(19) United States
(12) Patent Application Publication
(10) Pub. No.: US 2011/0102562 A1
(43) Pub. Date: May 5, 2011

(54) MULTI-SPECTRAL STEREOGRAPHIC DISPLAY SYSTEM WITH ADDITIVE AND SUBTRACTIVE TECHNIQUES

(75) Inventors: Robert L. JOHNSON, JR., Brattleboro, VT (US); Benjamin Fitch Price, Brattleboro, VT (US); John James Galt, Glendale, CA (US)

(73) Assignee: PV Omega, LLC, Woodland Hills, CA (US)

(21) Appl. No.: 12/938,335

(22) Filed: Nov. 2, 2010

Related U.S. Application Data
(63) Continuation-in-part of application No. 12/649,202, filed on Dec. 29, 2009.
(60) Provisional application No. 61/257,798, filed on Nov. 3, 2009.
(60) Provisional application No. 61/324,714, filed on Apr. 15, 2010.

(51) Int. Cl. H04N 13/04; H04N 15/00

(52) U.S. Cl. 348/58; 348/60; 348/E13.033

(57) ABSTRACT

A multi-spectral stereoscopic display system with additive and subtractive techniques is disclosed. Stereographic images may be presented and viewed via two sets of spectral bands that may have low or no overlap with each other. The color balances of a left-eye image and a right-eye image may be almost matching or identical. The left-eye image and the right-eye image may each be a full-color image with neutral color balance, even without modifying the color balance of original image content. Additive and subtractive techniques may provide spectral content within these sets of spectral bands. Subtractive techniques may include spectral filters. Additive techniques may include multi-spectral illuminants. An arrangement of a set of spectral bands may correspond to natural resonant characteristics. The spectral bands may be determined independently of conventional RGB designation of spectral bands. This system may operate independently of polarization techniques and electronic processes for color balance modifications.

### CROSS-REFERENCE TO RELATED APPLICATIONS

This application claims the benefit of U.S. Provisional Application No. 61/257,798, filed on Nov. 3, 2009, and U.S. Provisional Application No. 61/324,714, filed on Apr. 15, 2010. This application is a continuation-in-part (CIP) of U.S. application Ser. No. 12/649,202, filed on Dec. 29, 2009, which claims the benefit of U.S. Provisional Application No. 61/257,798, filed on Nov. 3, 2009. The contents of the applications above are incorporated by reference herein in their entirety for all purposes.

### FIELD

This invention relates generally to stereoscopic display systems that may provide an experience of stereo vision through multi-spectral techniques.

### BACKGROUND

Stereo vision involves two distinct images of the same visual target: a first image of the visual target for a left eye and a second image of the same visual target for a right eye that derives from a slightly different perspective. Due to the distance between the left and right eyes, the eyes are located at viewing positions that are slightly different from one another. Normal viewing presents each eye with a slightly different image of the same visual target. The brain uses the differences in the images to provide a sensation of the depth aspects of the visual target.

Similarly, stereoscopic display systems (often referred to as 3D) present two slightly different images to the viewer's eyes in order to simulate the normal stereo visual response to real-world objects and create a similar sense of depth.

FIG. 1 illustrates some basic principles of some existing stereographic display systems. In system 100, two sets of images can be presented on a display 103. A first set could comprise images 150 for the visual perspective of the left eye 105, and a second set could comprise images 160 for the visual perspective of the right eye 106. A viewer may view display 103 through a viewing means 102 (e.g., eyeglasses, a heads-up display, or filters suspended between the eyes and the display) that preferentially places separate images 170 before the left eye and separate images 180 before the right eye. Images 150 for the left eye may appear similar, even identical, to images 170 for the left eye. Similarly, images 160 for the right eye may appear similar, even identical, to images 160 for the right eye. The purpose of separating images for the left eye is to present the first set of images to the left eye while preventing the presentation of the second set of images to the left eye. Similarly, the purpose of separating images for the right eye is to present the second set of images to the right eye while preventing the presentation of the first set of images to the right eye. Thus, viewing means 102 may preferentially place before the left eye images 170 intended for the visual perspective of left eye 105, and the viewing means may preferentially place before the right eye images 180 intended for the visual perspective of right eye 106. Thus, the viewer may experience stereo vision as described above.

Historically, stereographic display systems have utilized anaglyph filters, polarization filters, shuttered glasses, or interference filters. However, previous examples of each of these systems have had shortfalls in either the viewing experience or the cost of implementation.

The most common method is the use of an anaglyph system of two discrete color bands that are created by absorbing pigments. An anaglyph system may separate left and right eye images into these two discrete color bands (typically predominantly red for one eye and predominantly cyan or blue for the other eye). Although filters of this type are inexpensive, they have not provided good separation of left and right eye images and the resulting crosstalk reduces the stereoscopic effect. For example, left eye images may undesirably pass through a right eye filter to the right eye. Also, anaglyph systems have provided poor color rendition.

A second approach is to utilize either linear or circular polarization filters in both the display and viewing means (e.g., glasses). However, projection systems employing polarization usually require specialized equipment (e.g., metallic display screens on which to present the images to be viewed) in order to preserve the polarization of the light from the display. Adding any such equipment introduces additional costs of implementation. For example, in projection systems, metallic screens are generally more costly to implement than the more commonly available achromatic screens, i.e., white screens or screens without color, typically used in projection systems of standard (or 2D) images. Movie theaters, for example, would have to install these special metallic screens specifically for stereographic viewing.

A third approach is to temporally separate left and right eye images using active liquid crystal shuttered glasses synchronized with the display system. Images for the left eye and images for the right eye are alternately displayed in time, and the shutter for each eye may open and close in synchronization with the displayed images. However, the shuttered glasses are bulky and expensive to produce.

Finally, another approach is to use interference filters to produce two distinctly separate sets of wavelengths specifically in the commonly-termed red, green, and blue (RGB) bands of the visible spectrum. An exemplary system has been demonstrated that requires both display filters and filters for the viewing means that have very sharp cutoffs within their respective spectral pass-bands. These filters are very expensive to manufacture, and their spectral pass-bands can cause left and right eyes to see images with significantly different color balances. That is, the color balance of images for one eye is significantly different than the color balance of images for the other eye. This system uses electronic processes to provide color balance modifications that compensate for these differences through a single, common color gamut triangle. Also, this system relies on glasses with complex filter designs, making this system not cost-competitive for high-volume applications such as theatrical cinema presentation. Moreover, this example is limited to utilizing only spectral bands specifically fixed as RGB-designated bands for both left-eye and right-eye images.

Several preceding inventions are related to one or more of the embodiments disclosed hereinbelow. U.S. Pat. No. 5,646,781 describes spectral bands that stimulate multiple visual sensors. U.S. Pat. No. 5,173,808 describes the ability to see very clearly with limited and specific bands in the blue, green, and red regions of the visible spectrum. U.S. Pat. No. 5,646,781 makes reference to the relative thickness of layers. Both U.S. Pat. Nos. 5,173,808 and 5,646,781 are herein incorporated by reference.

### SUMMARY

This invention relates generally to stereoscopic display systems that may provide an experience of stereo vision through multi-spectral techniques.

These multi-spectral techniques may involve apportioning portions of an operating spectral range (e.g., a spectral range visible to a human) into two sets of spectral bands that may have low or no overlap with each other. In some techniques, light of each set of spectral bands may stimulate the same color sensation (including a sensation of white light), even though their respective spectral content differs from each other. In some techniques, first and second white points respectively corresponding to the two sets of spectral bands may be both located within the same discrimination space for low or no color difference. In some techniques, this discrimination space may be an achromatic discrimination space for neutral color.

Some or all of these multi-spectral techniques may be incorporated in a multi-spectral stereoscopic image presenting apparatus (e.g., a film or digital projector, a television, a computer monitor) or in a multi-spectral stereoscopic image viewing apparatus (e.g., eyeglasses). When employed together in a system, a multi-spectral stereoscopic image presenting apparatus and a multi-spectral stereoscopic image viewing apparatus may provide an experience of stereo vision.

These multi-spectral techniques may be embodied through various ways, such as thin-film optical interference filters formed from stacks of thin layers of dielectric materials. The filters may be designed based on basic unit structures of dielectric layers. Based on the natural resonant characteristics (e.g., natural band harmonics) of the basic unit structures, a filter may have corresponding pass-bands. These pass-bands may correlate closely with a set of spectral bands of the multi-spectral techniques. These filters may be incorporated into a multi-spectral stereoscopic image presenting apparatus (e.g., a film or digital projector, flat-screen displays, televisions, computer monitors, picture frames, hand-held viewing devices, head-mounted displays, vision testing equipment, etc.) or in a multi-spectral stereoscopic image viewing apparatus (e.g., eyeglasses) or both.

Proper design of two distinct sets of pass-bands with low or no overlap may lead to two corresponding white points based on the same reference illuminant. In some embodiments, both white points may be located within the same discrimination space for low or no color difference. As a corresponding result, the color balance of filtered images from one distinct set of pass-bands may be almost matching or even identical to the color balance of filtered images from the other distinct set of pass-bands. Modifications to the color balance of original image content may be unnecessary to achieve this corresponding result.

In some embodiments, this discrimination space may be an achromatic discrimination space for neutral color. As a corresponding result, each distinct set of pass-bands may produce a full-color image with neutral color balance. This effect may provide a more natural experience of stereo vision. Modifications to the color balance of original image content may be unnecessary to achieve this corresponding result.

Various aspects of the multi-spectral techniques may contribute to low costs of implementation. For example, the experience of stereo vision may be provided without relying on polarization-maintaining techniques. Therefore, embodiments of the present invention can be used in projection systems with a diffuse white surface display screen such as the projection screens found in the majority of the world's cinemas. These teachings, in other embodiments, may also work with metallic-surface projection screens. Therefore, there may be low or no costs relating to altering existing screens.

These multi-spectral techniques may also provide a satisfactory experience of stereo vision without any electronic processing in order to provide a color balance modification that compensates for differing color balances in presented images. Therefore, there may be low or no costs related to this kind of electronic processing.

Additionally, various aspects of the filters may contribute to low costs of implementation. The design of the filters is elegant in employing the natural resonant characteristics (e.g., natural band harmonics) of just a single basic unit structure to provide all the pass-bands with the corresponding desired white point. This elegant design may contribute to low costs of implementation because it may be much simpler and involve many fewer layers than a more complicated filter design based on shaping each pass-band individually.

Another remarkably simple aspect of producing the filters is that a first filter for one eye may serve as base filter for designing a second filter for the other eye. The thickness of each layer of the second filter may be substantially determined by increasing (or decreasing) a corresponding layer thickness of the base filter by a constant factor. In other words, a single base filter design may contribute to low costs of implementation because filters for both eyes may be based on a single filter design instead of independently designing and producing each filter for each eye separately.

The purity of the spectral separation between pass-bands of a filter may be adjusted by simply changing the number of iterations of the basic unit structure in the filter. Such a simple technique may contribute to lower costs of filter design and production.

In an exemplary projection embodiment, a particular level of quality may involve a corresponding total level of filtering quality. With relatively greater filter complexity in a projection filter, the exemplary projection embodiment may provide satisfactory stereo vision experiences with a relatively simpler viewing filter. The viewing filter may be incorporated into a viewing apparatus, such as viewing glasses. In the exemplary projection embodiment, viewing glasses may be mass-produced for a mass audience. Minimizing the unit cost of viewing glasses should contribute to lower costs of implementation overall. Simpler viewing filters may lead to a lower unit cost of production for the viewing glasses.

The multi-spectral techniques embodied through thin-film optical interference filters may operate by subtracting spectral content from an input spectrum. The remaining spectral content may be located within a desired set of spectral bands. For instance, the filters may remove undesired spectral content from light of one or more illuminants so that the remaining spectral content may be located within the first and second sets of spectral bands. The multi-spectral techniques may also be embodied by adding spectral content so that the added spectral content may be located within desired sets of spectral bands. For instance, a multi-spectral illuminant having one or more light sources may provide light with multiple desired emission bands. For embodiments employing multiple light sources, each light source may provide one or more emission bands of light with spectral content within one or more desired spectral bands. Emission bands may be added together to form a spectrum with the multiple desired emission bands.

An exemplary light source that adds spectral content may be incorporated into a multi-spectral stereoscopic image presenting apparatus (e.g., a film or digital projector, flat-screen displays, televisions, computer monitors, picture frames, hand-held viewing devices, head-mounted displays, vision testing equipment, etc.). A multi-spectral thin-film optical interference filter, as discussed above, may be incorporated into the multi-spectral stereoscopic image presenting apparatus in combination with the exemplary light source.

The same spectral content may be provided through additive techniques (e.g., through one or more light sources, as discussed above) as through subtractive techniques (e.g., through one or more spectral filters, as discussed above). Accordingly, the same color balance aspects (e.g., same color sensation, white points, discrimination space for low or no color difference, neutral color balance) may be provided through adding spectral content as through subtracting spectral content. Furthermore, same spectral content may also be provided through combinations of additive and subtractive techniques.

Modifying the spectral content of the desired spectral bands may adjust the color balancing of the multi-spectral spectrums of the various inventive embodiments. The spectral content of a spectral band may be modified in multiple aspects, such as amplitude, width, and location. For instance, such modifications may enable adjustment of white point location.

Various multi-spectral techniques and teachings described above and further discussed herein exemplify practical implementations that recognize insights about issues involved in stereographic display technologies, such as the complexities of color vision (e.g., as in the human eye), which may be widely misunderstood. Accordingly, various embodiments of the invention may incorporate various teachings contrary to some conventional expectations. For instance, conventional stereographic display technologies rely on wavelength bands specifically fixed as conventional RGB-designated bands. In contrast, some embodiments of the invention may employ bands determined independently of such conventional RGB designation of spectral bands. Such unconventional practices may lead to various and unexpected results and benefits.

### BRIEF DESCRIPTION OF THE DRAWINGS

FIG. 1 illustrates some basic principles of some existing stereographic display systems.

FIG. 2A illustrates an example inventive embodiment.

FIG. 2B illustrates alternate arrangements of spectral bands.

FIG. 2C illustrates various ways to modify spectral content of a spectral band.

FIG. 3A illustrates a chromaticity diagram with white points of example inventive embodiments.

FIG. 3B illustrates a chromaticity diagram with example discrimination spaces.

FIG. 3C illustrates a magnified view of FIG. 3A with example discrimination spaces and additional white points.

FIG. 4A illustrates a basic unit structure of a thin-film optical interference filter for an example inventive embodiment.

FIG. 4B illustrates an example filter employing multiple iterations of the basic unit structure of FIG. 4A.

FIG. 4C illustrates light propagation for a Fabry-Perot etalon.

FIG. 4D illustrates light propagation for a structure with two spacer layers.

FIG. 5A illustrates an example inventive projection embodiment.

FIG. 5B illustrates a single-projector embodiment of FIG. 5A.

FIG. 5C illustrates a dual-projector embodiment of FIG. 5A.

FIG. 5D illustrates an example system with a single-projector embodiment including an “over-under” configuration.

FIG. 5E illustrates an example system with a rotating filter wheel.

FIG. 6 illustrates the representative operation of example filters in FIG. 5A.

FIG. 7A illustrates exemplary inventive backlight embodiments with spectral filters.

FIG. 7B illustrates an example inventive edge-lit backlight embodiment with spectral filters.

FIG. 8A illustrates an exemplary multi-spectral illuminant embodiment.

FIG. 8B illustrates details of an example variation of a multi-spectral illuminant embodiment.

FIG. 8C illustrates exemplary variations of light sources of a multi-spectral illuminant embodiment.

FIG. 9A illustrates an example inventive projection embodiment with a multi-spectral illuminant.

FIG. 9B illustrates a single-projector embodiment of FIG. 9A.

FIG. 9C illustrates a dual-projector embodiment of FIG. 9A.

FIG. 10A illustrates exemplary inventive backlight embodiments with multi-spectral illuminants.

FIG. 10B illustrates an example inventive edge-lit backlight embodiment with multi-spectral illuminant techniques.

FIG. 10C illustrates an example inventive direct-lit backlight embodiment with multi-spectral illuminants.

FIG. 10D illustrates variations of arrangements of multi-spectral illuminants in an example inventive direct-lit backlight embodiment

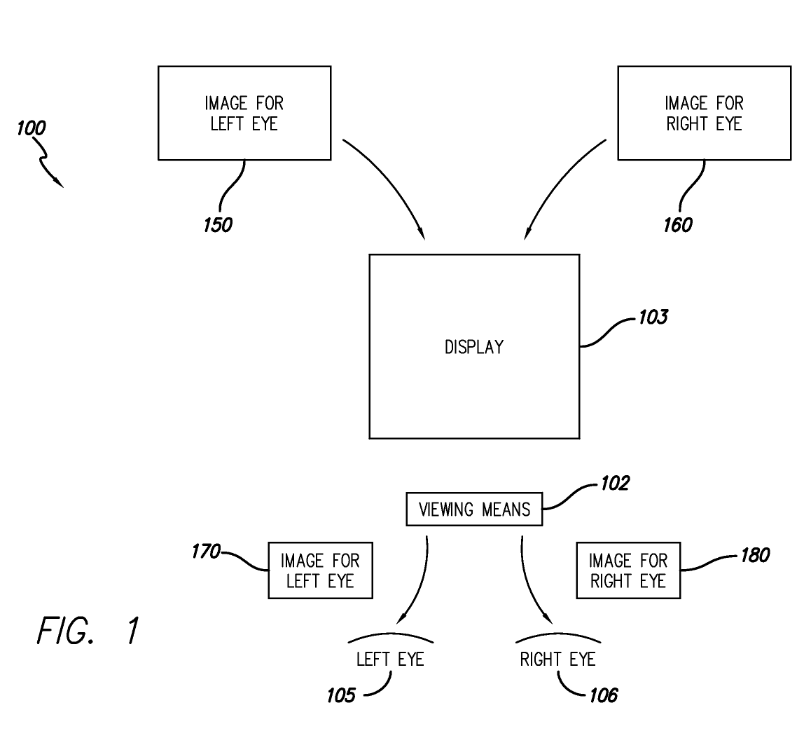

### DETAILED DESCRIPTION OF THE DRAWINGS

In the following description of example embodiments, reference is made to the accompanying drawings in which illustrative specific embodiments that can be practiced are shown. One of skill in the relevant art will understand that other embodiments can be used and structural changes can be made without departing from the scope of the claimed invention.

Multi-Spectral Stereographic Display

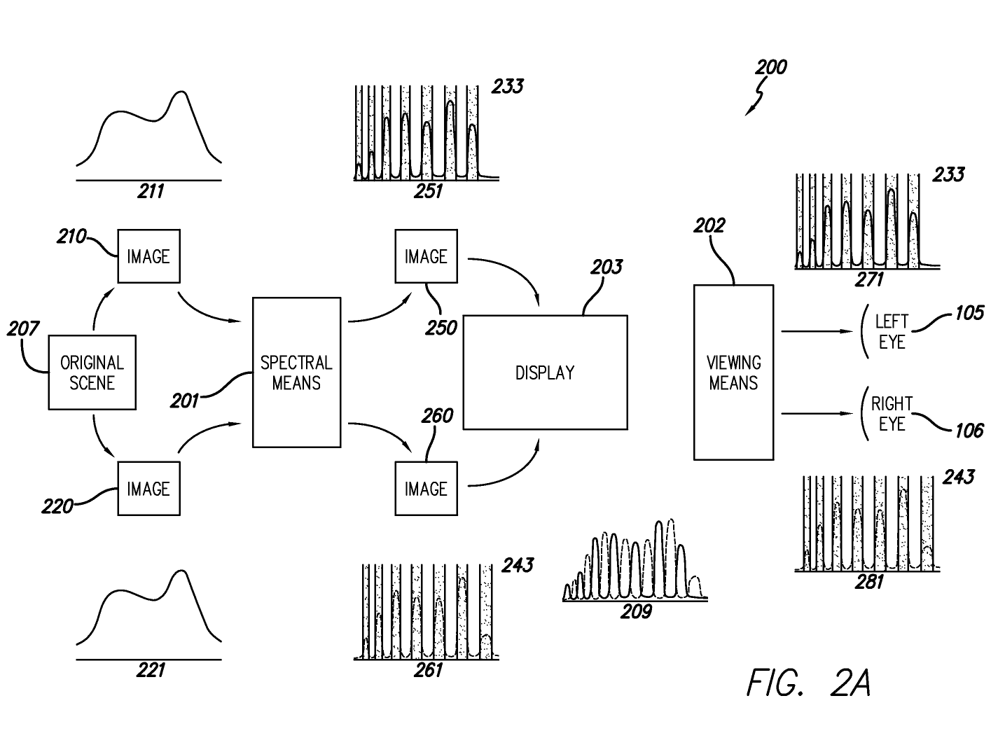

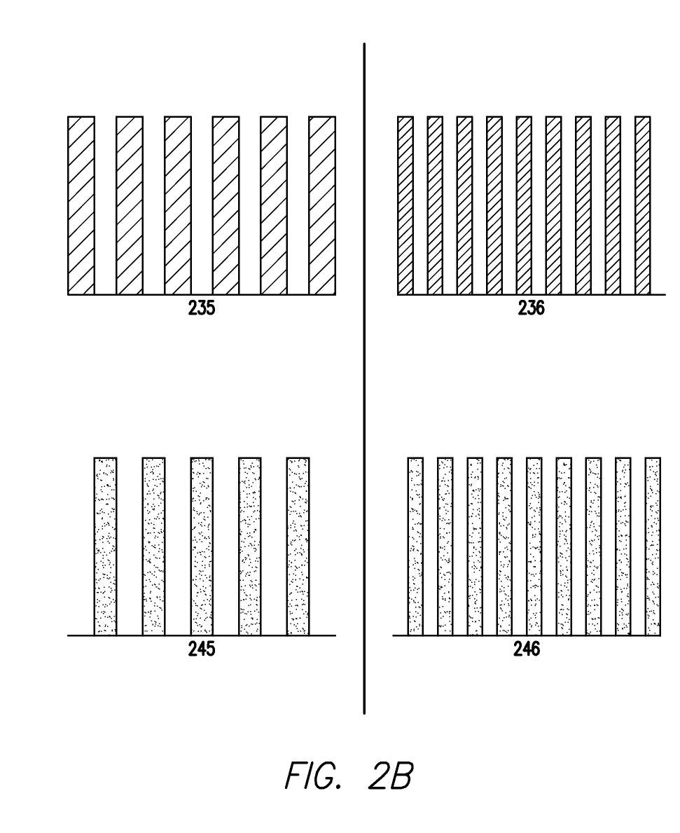

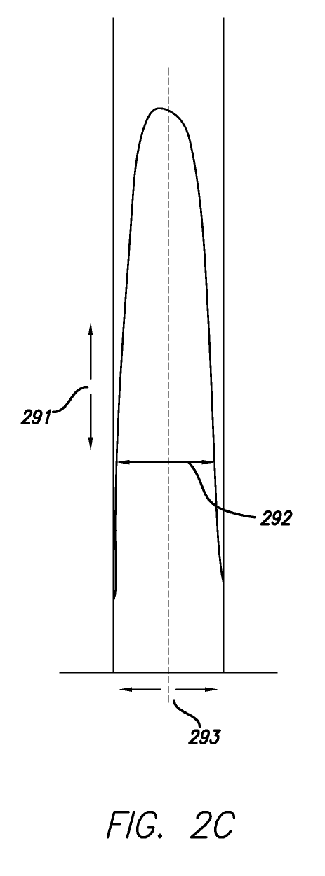

FIG. 2A illustrates an exemplary embodiment for providing a multi-spectral stereographic display 200. Stereo vision of an original scene 207 may be captured in two sets of images. Image 210 may comprise an image for the left-eye visual perspective of original scene 207. Image 220 may comprise an image for the right-eye visual perspective of original scene 207. Image 210 may have spectrum 211. Image 220 may have spectrum 221. As image 210 and image 220 may represent different visual perspectives of the same original scene, spectrum 211 and spectrum 221 may be very similar, or even identical, in spectral content.

Image 210 and image 220 may be input to spectral means 201, which may output image 250 with spectrum 251 and image 260 with spectrum 261, respectively. Spectral means 201 causes changes in spectral content from spectrum 211 to spectrum 251 and from spectrum 221 to spectrum 261. For example, spectral means 201 may process the spectrum of a left-eye image, within an operating spectral range, into a processed spectrum. For a more specific example, spectral means 201 may comprise a spectral filter with a set of pass-bands, which filters the spectrum of a left-eye image, within the visible spectrum, into a filtered spectrum. For another specific example, spectral means 201 may comprise a set of one or more light sources that provide emission bands of light. Spectral content of the emission bands may be located within a particular set of spectral bands within the visible spectrum. Corresponding principles may apply for the right-eye aspects of spectral means 201.

Various bands within the operating spectral range may be apportioned into a set of spectral bands 233 and a set of spectral bands 243. For example, in an exemplary operating spectral range of 400-700 nm, set 233 may include the following seven bands in nm: 412-424, 436-447, 463-478, 497-514, 536-558, 583-609, and 640-667. Set 243 may include the following seven bands in nm: 428-436, 451-463, 480-496, 516-535, 558-582, 609-637, and 667-697. The spectral bands of set 233 and set 243 may have low or preferably no overlap with each other.

Spectrum 251 may include spectral content within the set of spectral bands 233. The spectral bands of set 233 may contain the content of spectrum 251, i.e., the spectral content of image 250. Spectrum 261 may include spectral content within the set of spectral bands 243. The spectral bands of set 243 may contain the content of spectrum 261, i.e., the spectral content of image 260. Spectral means 201 may employ an exemplary number of bands, e.g., 14 total bands across the operating spectral range comprising seven bands for spectrum 251 and seven bands for spectrum 261. The operating spectral range may be selected to match or fall within the visible spectrum of a human viewer, e.g., a spectrum range of approximately 400-700 nm.

Other exemplary operating spectral ranges may occupy other portions of the electromagnetic spectrum. For example, an exemplary range may span a narrower range (e.g., 550-600 nm) within the visible spectrum range of approximately 400-700 nm. Another exemplary range may span a wider range (e.g., 300-1000 nm) that includes the visible spectrum range of approximately 400-700 nm. An exemplary range may span an infrared portion of the electromagnetic spectrum, such as 700-3000 nm. Another exemplary range may span an ultraviolet portion of the electromagnetic spectrum, such as 10-400 nm.

Image 250 and image 260 can be presented on display 203. Display 203 may be embodied as a viewing space, such as the viewing spaces of a television, a computer monitor, a movie screen, a picture frame, a hand-held viewing device, head-mounted display, vision testing equipment, etc. Image 250 and image 260 may be displayed in various temporal arrangements, e.g., simultaneous display, alternating display sequences, combinations of simultaneous display and alternating display sequences, etc.

Overlay 209 shows spectrum 251 and spectrum 261 superimposed upon each other. As illustrated in overlay 209, spectrum 251 and spectrum 261 may have low or preferably no overlap in spectral content.

Viewing means 202 may present most or all of the spectral content of the spectral bands of set 233 to the left eye 105 of a viewer through spectrum 271. Viewing means 202 may also prevent the presentation of most or all of the spectral content of the spectral bands of set 243 to the left eye 105 of the viewer. Viewing means 202 may present most or all of the spectral content of the spectral bands of set 243 to the right eye 106 of a viewer through spectrum 281. Viewing means 202 may also prevent the presentation of most or all of the spectral content of the spectral bands of set 233 to the right eye 106 of the viewer. An exemplary embodiment of viewing means 202 (e.g., eyeglasses, a heads-up display, or filters suspended between the eyes and the display) may include a left-eye spectral filter with a first set of pass-bands and a right-eye spectral filter with a second set of pass-bands. These pass-bands may correlate closely with the spectral bands of set 233 and set 243. As the spectral bands of set 233 may contain the spectral content of image 250, the left eye 105 of the viewer could be stimulated to see image 250. As image 250 may constitute an image of original scene 207 for the left-eye visual perspective, the viewer may experience a visual sensation of a left-eye perspective of the original scene from the viewer's own left eye 105. As corresponding processes may apply for the viewer's right eye 106, the viewer may experience a visual sensation of a right-eye perspective from the viewer's own right eye 106. Through the combined effect of these visual sensations, the viewer would experience stereo vision of original scene 207.

Color Perception by the Viewer

In embodiments of the present invention, each eye may be stimulated by less spectral content through viewing means 202 than the full spectral content available through directly viewing original scene 207. Nevertheless, the viewer may experience the unexpected result of seeing a full-color image with neutral color balance for each eye through viewing means 202. For example, a neutral color of white seen in the original scene 207 may still be seen as white through viewing means 202. Similarly, a color of blue (or red, yellow, green, violet, etc.) seen in the original scene 207 may still be seen as blue (or respectively red, yellow, green, violet, etc.) through viewing means 202. In contrast to images with a color bias, this effect may provide a more natural experience of stereo vision. Herein, “neutral color balance” is defined to include any color balances that may appear neutral to a viewer, as opposed to only one exclusive, absolute, unique, reference neutral color balance.

Each eye may be stimulated with different spectral bands of wavelengths, even mutually exclusive spectral bands, as compared to the other eye. Nevertheless, the viewer may experience the unexpected result of seeing a left-eye image and a right-eye image with almost matching, or even identical, color balances. For example, white (or red, yellow, green, blue, violet, etc.) visual objects seen in the left-eye image may also be seen as white (or respectively red, yellow, green, blue, violet, etc.) in the right-eye image.

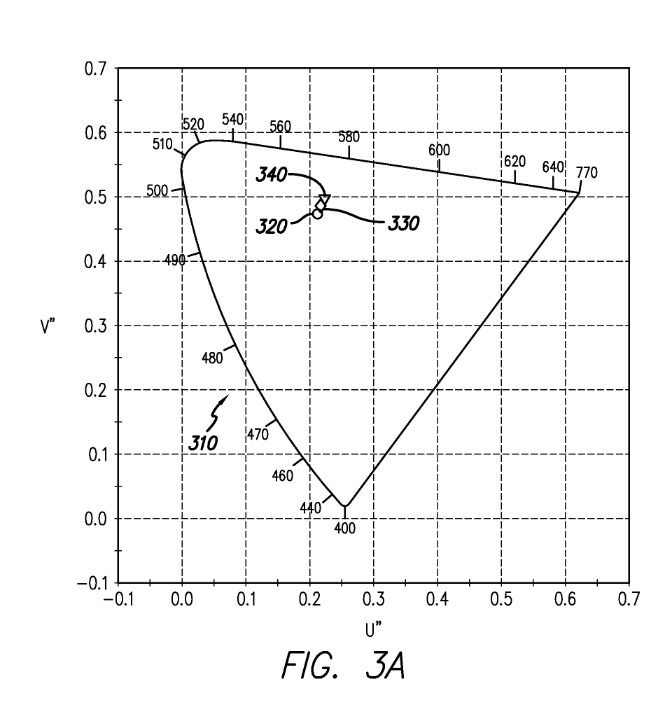

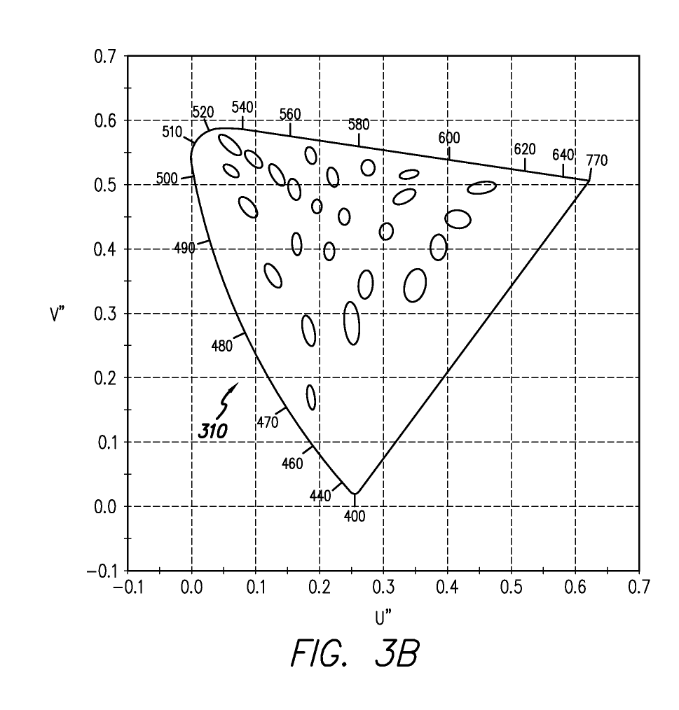

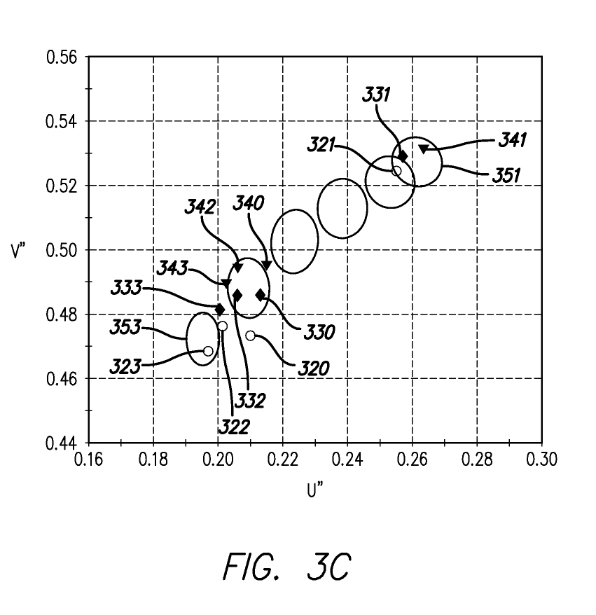

Such unexpected phenomena may be illustrated by the example chromaticity diagram in FIG. 3A, according to the CIE 1976, or CIELUV, uniform chromaticity scale diagram. The area within the boundary of the large curved shape 310 represents the colors capable of being perceived by the human eye. The numbers along the large curve indicate the mapping location of defined light wavelengths on the diagram. The circle 320 indicates the “white point,” or achromatic point, of an exemplary reference illuminant, such as the reference illuminant known as standard illuminant E. The white point of an illuminant may be understood as the chromaticity (i.e., the location in chromaticity coordinates) of a neutral color (e.g., white or gray) object when illuminated by the illuminant. The white point of an illuminant does not necessarily mean that a neutral color object will appear white when illuminated by the illuminant. For example, an illuminant may be biased in color so that its “white point” may be far from a chromaticity that would appear white to an observer.

The diamond 330 indicates an exemplary white point of light presented to the left eye through an exemplary first spectral filter according to embodiments of the invention. The triangle 340 indicates an exemplary white point of light presented to the right eye through an exemplary second spectral filter according to embodiments of the invention.

Circle 320, diamond 330, and triangle 340 are all based on the “equal energy” reference illuminant known as standard illuminant E. The “equal energy” reference illuminant has a spectrum where the spectral power distribution across the spectrum range is uniform. That is, the power value for each wavelength in the spectrum is equal.

In the example of FIG. 3A, circle 320 is very close to diamond 330, so the color balance seen in the original scene may appear very close, or even identical, to the color balance seen by the left eye. Circle 320 is also very close to triangle 340; so the color balance seen in the original scene may also appear very close, or even identical, to the color balance seen by the right eye. Diamond 330 and triangle 340 are very close to each other, so their color balances may appear very close, or even identical, to each other.

The proximity of the white points of circle 320, diamond 330, and triangle 340 may be described more definitely in terms of known and quantifiable metrics. FIG. 3B provides one exemplary description through a chromaticity diagram with example discrimination spaces for low or no color difference known as MacAdam ellipses. The MacAdam ellipses in FIG. 3B may not be drawn to scale, but may be enlarged for ease of understanding represented principles. Each discrimination space of a MacAdam ellipse shows an area where different chromaticity points within the same space may be indistinguishable from each other in color to a human eye. MacAdam ellipses may also be described in terms of degree or “steps,” which correspond to steps of increasing ellipse sizes. For example, a 2-step MacAdam ellipse is larger than a 1-step MacAdam ellipse. Within a smaller MacAdam ellipse, there is a greater probability that different chromaticity points would be perceived as the same color. The process for producing MacAdam ellipses of various steps is well known to those skilled in the art, so details about the process are not included here.

FIG. 3C illustrates a magnified view of FIG. 3A with example discrimination spaces and additional white points. FIG. 3C includes groupings of white points based on other exemplary reference illuminants: standard illuminant A, an exemplary Xenon arc lamp used in cinema projection, and standard illuminant D65. In each grouping, a circle represents the white point of the corresponding reference illuminant. A diamond represents the white point of the exemplary first spectral filter according to embodiments of the invention based on the corresponding reference illuminant. A triangle represents the white point of the exemplary second spectral filter according to embodiments of the invention based on the corresponding reference illuminant. For example, circle 320, diamond 330, and triangle 340 form a grouping of white points based on standard illuminant E.

Circle 321, diamond 331, and triangle 341 form a grouping of white points based on standard illuminant A. Circle 322, diamond 332, and triangle 342 form a grouping of white points based on the exemplary Xenon arc lamp used in cinema projection. Circle 323, diamond 333, and triangle 343 form a grouping of white points based on standard illuminant D65. Altogether, these various groupings form a profile for the same set of exemplary first spectral filter and exemplary second spectral filter according to embodiments of the invention.

FIG. 3C also shows exemplary discrimination spaces through a set of 7-step MacAdam ellipses from the U.S. Department of Energy (DOE) Energy Star program (version 4.0) for Compact Fluorescent Lamps. For each grouping of white points based on a reference illuminant, the proximity of the corresponding circle, diamond, and triangle is on a similar scale with the 7-step ellipses. In some cases, a grouping may actually fall within one of the DOE 7-step MacAdam ellipses, e.g., the grouping 321, 331, 341 for standard illuminant A falls within ellipse 351. Accordingly, a suitable grouping may be at least within the discrimination space of a 7-step MacAdam ellipse or even a smaller MacAdam ellipse.

In FIG. 3C, a grouping may fall within the same discrimination space of a suitably sized MacAdam ellipse. The inclusion of a diamond and a triangle of the same grouping in the same MacAdam ellipse means that a human viewer may perceive almost matching, or even identical, color balances in left-eye and right-eye images provided by viewing means according to some embodiments of the invention. The inclusion of a circle of the same grouping in the same ellipse means that a human viewer may perceive almost the same, or even identical, color balance when using viewing means according to some embodiments of the invention as compared to directly viewing an original scene illuminated by the corresponding reference illuminant.

The area of the CIE 1976, or CIELUV, uniform chromaticity scale diagram shown in FIG. 3C includes achromatic discrimination spaces. For example, the inclusion of circle 323 in ellipse 353 indicates that this particular MacAdam ellipse 353 may be an achromatic discrimination space because circle 323 refers to standard illuminant D65, which is known as appearing achromatic to the human eye as daylight. As another example, a suitably sized MacAdam ellipse including circle 320 would also indicate an achromatic discrimination space because circle 320 refers to standard illuminant D65, which is also known as appearing achromatic to the human eye. Various embodiments of the invention may also employ non-achromatic discrimination spaces.

Additionally, even though FIG. 3C shows the discrimination space of a 7-step MacAdam ellipse, the invention is not limited to this specific discrimination space. For example, other embodiments may include variations in the parameters of a discrimination space including, but not limited to, different size (e.g., a 4-step or a 10-step MacAdam ellipse) and different chromaticity location.

Furthermore, although the MacAdam ellipse represents one metric for color discrimination, one may describe and practice embodiments of the invention in terms of other metrics for color discrimination. For example, one may describe and practice embodiments of the invention in terms of spectral power distribution.

In the above description related to FIGS. 3A and 3C, the plotted points (i.e., the diamonds and triangles) are based on embodiments of the invention that may operate by subtracting spectral content from an input spectrum. The remaining spectral content may be located within desired sets of spectral bands (e.g., exemplary spectral filters removing undesired spectral content from light of a reference illuminant). Additionally, the same plotted points may be based on inventive embodiments that may operate by any other technique capable of providing spectral content located within the desired sets of spectral bands. Some other techniques may include adding spectral content so that the added spectral content may be located within the desired sets of spectral bands.

For example, in the above description, diamond 330 is based on a specific spectrum with spectral content within a first set of spectral bands. In an embodiment using subtractive techniques, this specific spectrum may result from the exemplary first spectral filter filtering light from standard illuminant E. In an embodiment using additive techniques, this specific spectrum for diamond 330 may also result from employing emission bands of light that include the same spectral content within the same first set of spectral bands. Such emission bands of light may be provided by any combination of one or more light sources that provide spectral content within the first set of spectral bands. Furthermore, this specific spectrum for diamond 330 may also result from combining subtractive and additive techniques.

These unexpected phenomena may be explained through the understanding that color is a conceptual construct. The perception of color is derived from the interaction of the spectrum of light with spectral sensitivities of visual receptors. For example, the Young-Helmholtz theory of trichromatic color vision states that the human eye has three distinct color receptors that are predominately sensitive to short, medium, and long wavebands of light (proximately grouped wavelengths). These three color receptors have been commonly referred to as blue, green, and red. More precisely, these three color receptors have also been designated as S for short, M for medium, and L for long. These wavebands fall within the visible spectrum (approximately 400-700 nm) of the electromagnetic spectrum. Human color vision is then derived from the combined effect of stimulating these color receptors.

In contrast, other organisms have visual receptors with different spectral sensitivities. For example, bees have visual sensitivity to radiation in the ultraviolet range of the electromagnetic spectrum. Rattlesnakes have visual sensitivity in the infrared range. Some birds have more than three color receptors.

Although real-world objects usually reflect a broad spectrum of light from the ultraviolet to the infrared, modern photographic processes; both for acquisition and display, rely on the Young-Helmholtz theory by utilizing relatively narrow bands of the visual spectrum to produce the sensation of color in various photographic capture and display systems. The bandwidths of the narrow bands utilized may be as narrow as one nanometer as exemplified by various laser illuminated display devices. Furthermore, it is not necessary that very specific bands of red, green, and blue be employed to produce the sensation of color. Even if two distinctly different sets of spectral bands have mutually exclusive spectral bands, each set, if chosen properly, can produce virtually any color, including the same color, with the proper proportions or admixtures. It is this principle that is exploited in the disclosed embodiments.

One common example of this phenomenon is fluorescent lighting. A first fluorescent lamp may have a spectrum with a first set of spectral peaks. A second fluorescent lamp may have a spectrum with a second set of spectral peaks that differs from the first set. However, a human viewer may see white light from both lamps.

Furthermore, human color vision is not strictly mapped to specific wavelengths of light. For example, in the simple case of a first green light containing only wavelengths in the “green” band of the spectrum, there would be the human perception of viewing the color “green,” as would be conventionally expected. However, in another case, the human perception of the color “green” in a green light may not require that the light exclusively contain wavelengths in the “green” band of the visible spectrum (i.e., wavelengths around 540 nm). In actuality, a second green light may contain wavelengths in the “blue” band (i.e., wavelengths around 465 nm) and wavelengths in the “red” band (i.e., wavelengths around 640 nm). The same color “green” may be perceived in both cases because the range of sensitivity for stimulation leading to the color perception of “green” is broad enough to include wavelengths in those different bands of wavelengths, not only in the “green” band. Thus, when a proper set of wavelengths of light, even excluding wavelengths of the “green” band, falls within this range of sensitivity, the resulting stimulation of the corresponding color receptors could, nonetheless, lead to the color perception of “green.” Therefore, the sensation of one particular color may be provided through a variety of different combinations of wavelengths.

Previous efforts in apportioning the visible spectrum for stereographic display, such as anaglyph systems, have focused on splitting the visible spectrum into two complementary spectral bands and filtering a left-eye image through the first band and a right-eye image through the second band. Such systems rely on the brain to fuse the stimulation of the two eyes together to produce the sensation of stereo vision. However, unlike the teachings of the disclosed embodiments provided in connection with FIGS. 2A and 3A-3C, such previous efforts have not been able to provide a viewer with the unexpected result of seeing a full-color image with neutral color balance for each eye. Rather, such previous systems have resulted in differing color balances between left-eye images and right-eye images, which provides an unnatural experience of color vision when viewing through only one eye at a time. For instance, instead of each eye naturally viewing images with the same color balance, images for one eye may be tinted red and images for the other eye may be tinted cyan through anaglyph filters. Also, the color balance for each eye would not be neutral. For instance, a neutral color (e.g., white or gray) in a displayed image would be tinted red through the red anaglyph filter (or cyan through the cyan anaglyph filter).

Previous efforts in apportioning the visible spectrum for stereographic display, such as the previously mentioned interference filter system, have also focused on using wavelengths specifically in the red, green, and blue bands of the visible spectrum to intentionally stimulate the corresponding L, M, and S color receptors of the human eye. For instance, some previous stereographic display efforts provided left-eye images based on a set of RGB-designated bands and right-eye images based on a non-overlapping set of RGB-designated bands. Compared to anaglyph techniques, such usage of mutually exclusive sets of RGB-designated bands may have resulted in left-eye images and right-eye images with less different color balances.

Such previous efforts with RGB-designated bands reflect a prevailing, standard RGB paradigm in display technologies to develop systems based on a foundation of utilizing bands specifically fixed as RGB-designated bands. This foundation can be understood through the existence of the three distinct L, M, and S color receptors in the human eye, as discussed above in relation to the Young-Helmholtz theory of trichromatic color vision. Proper stimulation of these three color receptors leads to full-color vision. Although these color receptors have been designated L, M, and S, they have also been called red, green, and blue. Thus, it has been widely believed that the most efficient way to provide full-color vision has been to utilize the minimum of three corresponding spectral bands (i.e., specifically red, green, and blue bands) to properly stimulate the “red, green, and blue” color receptors. For example, it has been widely believed that utilizing additional bands in regions outside of RGB-designated regions would introduce additional costs of accommodating the additional bands (e.g., additional light sources, additional filter pass-bands). On the other hand, it has been understood that undesired color bias could result from utilizing fewer than three bands

This RGB paradigm has guided development throughout the fields of image capture systems and image display systems, as evidenced through the standard practice of utilizing only specifically RGB light in various kinds of image capture and display technologies. Examples of such image capture technologies include various applications in chemical and electronic photography. Examples of such display technologies include cathode-ray tube (CRT), projection, liquid crystal display (LCD), and light-emitting diode (LED). The field of stereographic display has followed this RGB paradigm by establishing a basic system utilizing bands specifically fixed as red, green, and blue bands. Prior efforts add modifications to this basic RGB system while maintaining RGB aspects in any resultant modifications. For example, it has been common practice to designate certain bands as R, G, and B bands and to maintain distinct and separate R, G, and B spectral regions. Such maintenance of RGB aspects would be expected because one of ordinary skill in the art would want to maintain conceptual compatibility with other prevalent RGB technologies. In other words, prior stereographic display systems are based on the foundation of utilizing bands specifically fixed as RGB-designated bands. Thus, a stereographic display system not based on this RGB paradigm would be an uncommon practice in stereographic display technology.

Instead of the standard RGB-dependent paradigm, embodiments of the invention may be based on a completely different paradigm that is RGB-independent, which can have significant implications. For instance, a completely different paradigm may enable completely different design considerations, which can lead to completely different implementations. Under this RGB-independent paradigm, arrangements of spectral bands can be independent of (e.g., even free of) RGB designation of spectral bands and independent of (e.g., even free of) maintaining distinct and separate R, G, and B spectral regions. Conventionally, under the standard RGB-dependent paradigm, the human eye is presented with spectral content specifically from red, green, and blue wavelength regions of the visible spectrum, the combined spectral content providing the sensation of a full-color image. In contrast, under this RGB-independent paradigm, the human eye can be presented with any distribution of spectral content that stimulates the color receptors of the human eye sufficiently to provide the sensation of a full-color image. Due to such a broad scope of potential distributions, this RGB-independent paradigm may introduce a variety of technical implications.

One exemplary technical implication of the RGB-independent paradigm may be an increased range of possible spectral content arrangements. Thus, the variety of arrangements implemented in embodiments of the invention can be quite broad. Some embodiments of the invention may include arrangements of spectral content coinciding with arrangements of spectral content already found in RGB-designated systems. Some embodiments of the invention may also include arrangements of spectral content that incorporate teachings that deviate from the standard RGB paradigm. Some embodiments of the invention may also include spectral content arrangements that incorporate combinations of teachings applicable under the standard RGB paradigm and teachings that deviate from the standard RGB paradigm.

Some teachings that deviate from the standard RGB paradigm may include bands outside of RGB-designated regions. Conventional expectations of such bands may include costs of accommodating unconventional bands and undesired color bias. Nonetheless, some embodiments of the invention may include such bands outside of RGB-designated regions, for example, by including spectral content before a B-designated region, in between a B-designated region and a G-designated region, in between a G-designated region and a R-designated region, or after a R-designated region. Instead of providing color bias, however, the proper utilization of bands outside of RGB-designated regions may properly stimulate the three color receptors to provide images with neutral color balance.

Some teachings that deviate from the standard RGB paradigm may also include spectral content arrangements that employ a set of spectral bands lacking a conventional band fixed as a R, G, or B-designated band. Conventional expectations of such a set of spectral bands may include images that are not full-color since such a set of spectral bands would not follow the conventional practice of utilizing RGB-designated bands. Nonetheless, some embodiments of the invention may include, for example, spectral content arrangements that employ a left-eye (or right-eye) set of spectral bands lacking a conventional B (or G or R) band. Instead of providing image that are not full-color, however, the same left-eye set of spectral bands may suitably stimulate the corresponding left-eye blue color receptor through other non-conventional bands, resulting in a sensation of full-color vision.

The above two sets of teachings that deviate from the standard RGB paradigm are exemplary and not exhaustive. They merely illustrate some examples of potential technical distinctions from the standard RGB paradigm. Embodiments of the invention are not limited to these two sets of teachings and may incorporate none or one or both sets of teachings above.

Incorporating one or more of the above teachings deviating from the standard RGB paradigm may also provide various combinations of left-eye and right-eye sets of spectral bands that would further deviate from the standard RGB paradigm. One such combination may comprise two sets of bands, neither band having a complete base set of conventional RGB-designated bands, the number of bands in each set being greater than the number of types of color receptors in a target viewer. In contrast, prior efforts have relied on a base set of 3 bands specifically fixed as respectively R, G, and B-designated bands in at least a left-eye or a right-eye set of spectral bands.

Another exemplary combination may include two sets of bands, the number of bands in each set being greater than the number of types of color receptors in a target viewer. (For a common human viewer, there are 3 types of color receptors, i.e., L, M, and S, so each set could have 4 or more bands.) Along one direction in an operating spectral range (e.g., increasing in wavelength, decreasing in wavelength), spectral bands in one set may alternate with spectral bands in the other set. Inherently, each set of bands may form, a color gamut polygon having a number of vertices corresponding to the number of bands in the set. In accordance with the alternating sequence, the two color gamut polygons would inherently differ as the respective vertices would be different. Conventionally, one of ordinary skill in the art could expect such differing gamuts to provide differing color balances between left-eye and right-eye images. However, actual results of some embodiments of the invention utilizing this exemplary combination provide similar color balances for each eye, e.g., the white points of left-eye images and right-eye images being close to each other. In contrast, prior efforts (e.g., the electronic processing described above) have relied on a single target RGB color gamut triangle to provide images to both left and right eyes, not differing gamuts.

Yet another exemplary combination may include the combined teachings of the two exemplary combinations described immediately above.

In contrast to the conventional expectations of these teachings that deviate from the standard RGB paradigm, some embodiments of the invention may utilize combinations of one or more of these deviating teachings to provide unexpected results. For example, some embodiments of the invention (e.g., including the exemplary combinations described above) may provide images with exceptional neutral color balance for each eye (e.g., the white points of left-eye images and right-eye images being close to the white points of achromatic illuminants) with similar color balances for each eye (e.g., the white points of left-eye images and right-eye images being close to each other). Such unexpected results may be understood though the fact that even wavelength bands outside the commonly-termed RGB regions may stimulate L, M, and S color receptors of the human eye. Thus, the L, M, and S color receptors may be stimulated by sets of wavelength bands that differ from conventional RGB bands, still resulting in full-color vision.

Due to the increased range of possible spectral content arrangements, another exemplary technical implication of the RGB-independent paradigm is increased flexibility in design and implementation. Such flexibility increases the possibilities in system design and implementation, which has led to some embodiments of the invention with costs that are significantly less than the costs of previous efforts. For instance, a conventional interference filter for stereographic display is often designed by first carefully determining a target set of RGB-designated pass-bands that pass specifically RGB-designated bands. Then, a filter designer would try to develop a filter design that fits the constraint of this target set of RGB-designated pass-bands. However, interference filters of relatively simpler designs have pass-bands that do not align well with conventional sets of RGB-designated bands. Therefore, prior efforts have required complex modifications of relatively simpler designs to achieve the target set of RGB-designated pass-bands, thus requiring complex filter design implementations. In contrast, spectral bands of some embodiments of the invention may be determined independently of RGB designation of spectral bands. Rather, the spectral bands may be determined on a different basis. For instance, some embodiments of the invention include an interference filter that provides all of its passbands based on the natural resonant characteristics (e.g., natural band harmonics) of a single basic unit structure. In some cases, such a single basic unit structure may be significantly simpler and less costly to design and implement than the conventional interference filter described above.

Another exemplary technical implication of the RGB-independent paradigm may involve issues regarding compatibility with existing technologies. A conventional expectation of employing RGB-independent stereographic teachings could be incompatibility with existing RGB-dependent technologies. However, actual implementations of some embodiments of the invention have provided satisfactory performance with existing RGB-dependent technologies. Moreover, some embodiments of the invention may fit exceptionally well with film technologies that already employ RGB-independent techniques, such as RGB-independent illuminants (e.g., Xenon arc lamps). Furthermore, under the RGB-independent paradigm, teachings employed in RGB-dependent systems are not necessarily excluded from embodiments of the invention. Rather, the RGB-independent paradigm may allow broader application of such teachings. In other words, some embodiments of the invention may be combinable with some kinds of teachings previously applied in RGB-dependent systems. For example, while some embodiments of the invention may be free of electronic processes that provide color modifications, such electronic processes are not inherently excluded. Also, increased compatibility with RGB-dependent technologies may be achieved through various techniques, such as careful modifications in amplitude, width, and location of spectral bands to provide spectral bands that RGB-dependent technologies can utilize.

Additionally, it should be noted that some embodiments of the invention may combine one or more teachings related to each of the exemplary technical implications described above. Moreover, the exemplary technical implications described above are not exhaustive since the RGB-independent paradigm may allow for other exemplary technical implications available to various embodiments of the invention. Furthermore, the above discussions of the exemplary technical implications are not intended to define the invention. Rather, various embodiments of the invention may be described in light of the entire scope of this disclosure.

As another exemplary contrast to the previous efforts discussed above, by separating the range of the visual spectrum from approximately 400 to approximately 700 nanometers into two sets of spectral bands with low or no overlap, as exemplified in FIG. 2A (wherein originally neutral spectral content apportioned into each set would be perceived as neutral for its corresponding eye, as exemplified in FIGS. 3A and 3C), it is possible to produce almost the same, or even identical, color sensation in both eyes without any commonality of the visual spectrum in either eye image. In other words, various features may be provided by this arrangement of differing sets of spectral bands. One feature may be that each set may produce a full-color image with neutral color balance for its corresponding eye. Another feature may be that the color balance of the left-eye image and the color balance of the right-eye image may be almost matching or even identical. In contrast to images with a color bias, these features may provide a more natural experience of stereo vision.

Additionally, these features may be achieved without polarization-maintaining techniques. Therefore, embodiments of the present invention can be used in projection systems with a diffuse white surface display screen such as the projection screens found in the majority of the world's cinemas. These teachings, in other embodiments, may also work with metallic-surface projection screens.

Furthermore, these features may be achieved without using electronic processes that specifically provide color balance modifications that compensate for different color balances between left-eye images and right-eye images. In other words, some embodiments of the invention may be free of any electronic processing that provides a color balance modification that compensates for differing color balances.

Spectral Means

In the example of FIG. 2A, images 250 and 260 are provided for display 203 by spectral means 201. Spectral means 201 may be embodied by any suitable technique that provides images through spectral bands that follow the principles discussed above.

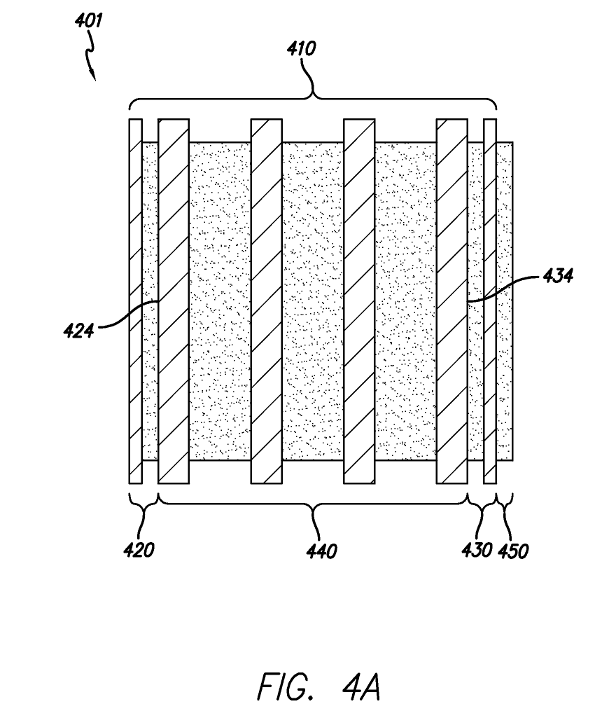

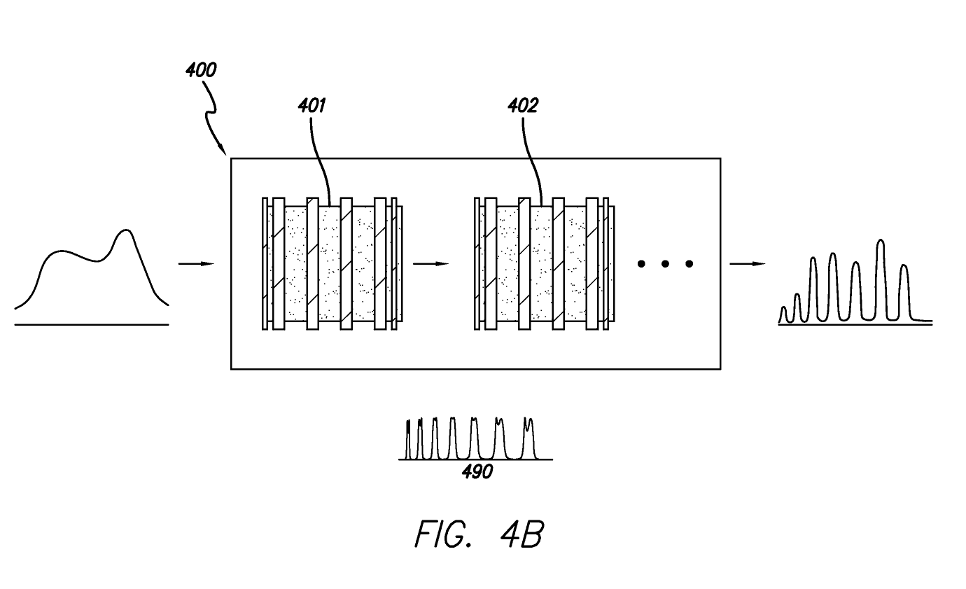

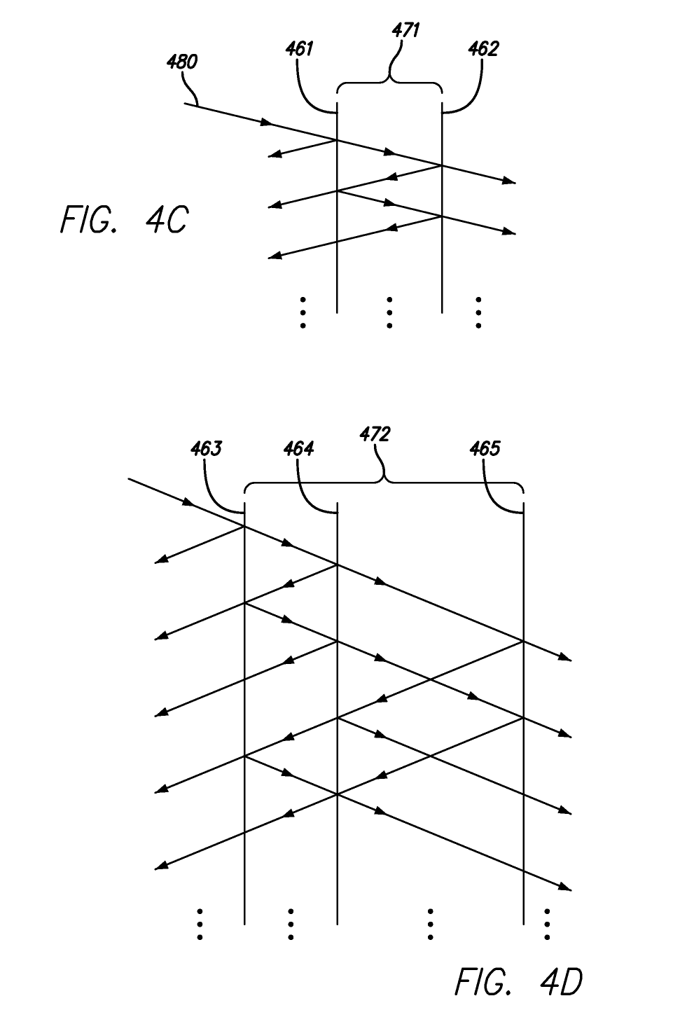

An exemplary embodiment for such a spectral means 201 may include optical spectral filters, e.g., optical interference filters, optical absorption filters, and diffraction gratings. Among optical interference filters, examples may include thin-film interference filters and holographic interference filters. More specifically, a thin-film interference filter with dielectric layers may be employed. FIG. 4A shows a basic unit 401 of such an exemplary filter. This example unit 401 has a basic structure including 12 dielectric layers. The final layer on the right side of the basic unit may be a transition layer 450 for the serial addition of another basic unit. In the remaining 11-layer stack 410, two sets of two layers each (each forming an end of the remaining stack 410 of 11 layers, thereby providing four layers total) provide reflecting portions 420 and 430. The seven inner layers provide a spacer region 440 having specific spacing arrangements between reflecting portions 420 and 430. At the interface between reflecting portion 420 and spacer region 440, reflecting portion 420 may provide a surface 424 with high reflectivity. At the interface 434 between reflecting portion 430 and spacer region 440, reflecting portion 430 may provide a surface 434 with high reflectivity. The surfaces of the inner layers may also provide some reflectivity.

This basic unit 401 may operate according to the principles of a Fabry-Perot etalon: a propagation medium (i.e., a spacer region 471) between two reflecting surfaces 461 and 462, as shown in FIG. 4C. As light 480 enters the etalon, light may reflect back and forth multiple times between reflecting surfaces 461 and 462, as indicated by the internal reflections in FIG. 4C. These internal reflections of light may interfere with each other. At certain wavelengths, there may be constructive interference. At such wavelengths, standing waves may form within the etalon, and light at these wavelengths may pass through the etalon. At other wavelengths, there may be destructive interference, preventing these other wavelengths from passing through the etalon. As a resonant cavity, a Fabry-Perot etalon may be understood as having natural resonant frequency bands where the standing waves may form. These frequency bands may correspond to the wavelength bands that may experience constructive interference and pass through the etalon. In terms of wavelength bands, such natural resonant frequency bands may also be understood as natural resonant wavelength bands. For a filter that operates according to these principles, the pass-bands of such a filter may be defined by these natural resonant wavelength bands. For simplicity, changes in propagation angles due to refraction are omitted in FIG. 4C. One skilled in the art will understand that this simplified drawing still illustrates the light interference discussed above.

With additional spacer layers in the spacer region (e.g., spacer region 472 with two layers between surfaces 463, 464, and 465 in FIG. 4D), the complexity of light interference in the spacer region may increase, as shown by the relatively greater complexity of FIG. 4D compared to FIG. 4C. For simplicity, changes in propagation angles due to refraction are omitted in FIG. 4D. One skilled in the art will understand that this simplified drawing still illustrates the light interference discussed above. Various parameters may be varied to achieve different filtering characteristics. Such parameters may include, but are not limited to, layer thicknesses, number of layers, and layer material.

When light enters basic unit 401 of FIG. 4A, particular wavelength bands may experience constructive interference among the inner spacing layers due to the natural resonant wavelength bands of the structure of basic unit 401. These particular wavelength bands may correspond to the pass-bands of the basic unit 401. Standing waves may form at those natural resonant wavelength bands, which may pass through the basic unit. The various surfaces between the various inner spacing layers may set up the cavity conditions for the various standing waves. From another perspective, the transmission response of the basic unit may have an appearance like a comb. Transmission peaks would indicate the wavelength bands passing through the basic unit.

FIG. 4A shows an exemplary basic unit comprising alternating layers of two materials with differing indices of refraction. The odd layers may have an exemplary index of refraction n=2.3, as shown by the diagonal hatching. The even layers may have an exemplary index of refraction n=1.5, as shown by the stippled hatching. Examples of materials can include, but are not limited to, Nb₂O₃, ZnS, TiO₂, etc. for the high “n” material, and SiO₂, 3NaFAlF₃, MgF₂, etc. for the low “n” material. High “n” material may have an index of refraction in the range of 2.0-2.5. Low “n” material may have an index of refraction in the range of 1.35-1.6. The thickness of a layer may be less than 1000 nm. Additionally, FIG. 4A shows alternating layers with alternating heights. However, the alternating heights may be merely illustrative to assist easy visual discrimination of the alternating layers.

When two layers have different indices of refraction, some amount of light reflection may occur at the interface between the layers. However, at certain wavelengths, constructive interference may occur within the basic unit, and light at these wavelengths may pass through the basic unit with low attenuation.

FIG. 4A illustrates the principles of the basic unit, and it is not intended to be a limiting embodiment. For example, in FIG. 4A, the number of inner spacer layers in spacer region 440 of basic structure 401 may match the number of pass-bands, but the scope of this disclosure includes embodiments in which they may not match. Additionally, other exemplary embodiments may include other total numbers of inner spacer layers, such as five or nine. Furthermore, the relative thicknesses of each of the layers in FIG. 4A may be merely illustrative as other exemplary embodiments may employ other sets of relative thicknesses:

Other variations may involve the reflecting portions at the ends of the spacer region. For example, FIG. 4A shows two layers in a reflecting portion 420 or 430, but other exemplary basic units may include more than two layers. FIG. 4A shows that the two layers are comprised of the same materials used in the inner spacer layers, but still other exemplary basic units may include materials used for the layers of the reflecting portion different from the materials used in the inner spacer layers.

An exemplary filter 400 may comprise one or more iterations of this basic unit 401, as illustrated in FIG. 4B. In a filter with multiple iterations, one basic unit 401 may be serially stacked after another similar or identical basic unit 402. More iterations may increase the purity of the filter, i.e., lower transmission of wavelengths outside the filter pass-bands and greater sharpness of the cut-off edges of the pass-bands. The pass-bands 490 of filter 400 in FIG. 4B exemplify operating principles of filter 400 but are not intended to precisely line up with the output spectrum from filter 400. Also, the embodiments of the invention are not limited to these specific pass-bands 490 and may include other pass-bands that follow the underlying operating principles exemplified by basic unit 401 and filter 400.

An exemplary basic unit of a filter with multiple iterations of the exemplary basic unit may have the following parameters:

TABLE A
Example basic unit structure in a first filter

| Layer number | Material | Thickness in nm |
|---|---|---|
| 1 | TiO₂ | 53.65 |
| 2 | SiO₂ | 86.35 |
| 3 | TiO₂ | 107.30 |
| 4 | SiO₂ | 345.40 |
| 5 | TiO₂ | 107.30 |
| 6 | SiO₂ | 345.40 |
| 7 | TiO₂ | 107.30 |
| 8 | SiO₂ | 345.40 |
| 9 | TiO₂ | 107.30 |
| 10 | SiO₂ | 86.35 |
| 11 | TiO₂ | 53.65 |
| 12 | SiO₂ | 86.35 |

The last layer (layer number 12) may be a transition layer for the serial addition of the next basic unit. In other words, the last layer may be a layer to link units.

In such an embodiment, each basic unit in the filter may be substantially similar, except for minor adjustments. For example, minor adjustments to the thickness of every layer can be made to optimize performance.

With reference to FIG. 2A, spectral means 201 may comprise a first filter for left-eye image 210 and a second filter for the right-eye image 220. The first filter may filter spectrum 211 to spectrum 251. The second filter may filter spectrum 221 to spectrum 261.

The first and second filters may have different transmission spectrums to provide the low or preferably no overlap between the spectral bands of set 233 and the spectral bands of set 243. In order to provide the different transmission spectrums, one filter may serve as a base filter. The other filter may be created by shifting the location of its pass-bands relative to the base filter. This effect may be achieved by increasing (or decreasing) each of the layer thicknesses of each of the basic units of the base filter by a constant factor, with tolerance for fine tuning adjustments. As standing wave wavelengths may be related to layer thicknesses, change in layer thicknesses may lead to change in the location of the filter pass-bands.

With the parameters (Layer number, Material, Thickness in nm) disclosed above as an exemplary basic unit of a base first filter, an exemplary basic unit of a second filter may have the following parameters:

TABLE B
Example basic unit structure in a second filter

| Layer number | Material | Thickness in nm |
|---|---|---|
| 1 | TiO₂ | 56.20 |
| 2 | SiO₂ | 89.83 |
| 3 | TiO₂ | 112.39 |
| 4 | SiO₂ | 359.32 |
| 5 | TiO₂ | 112.39 |
| 6 | SiO₂ | 359.32 |
| 7 | TiO₂ | 112.39 |
| 8 | SiO₂ | 359.32 |
| 9 | TiO₂ | 112.39 |
| 10 | SiO₂ | 89.83 |
| 11 | TiO₂ | 56.20 |
| 12 | SiO₂ | 89.83 |

Compared with parameters of the corresponding layers of the exemplary basic unit of a base first filter, the layers in this second filter would be thicker by a factor of 1.0396 or 3.96%, with tolerance for fine tuning adjustments. For example, the thickness of layer number 4 in the basic unit of the base first filter is 345.40 nm, and the thickness of layer number 4 in the basic unit of the second filter is 359.32 nm=(345.40 nm×1.0396 factor=359.08 nm)+0.24 nm of fine tuning.

The type of thin-film optical interference filter discussed above (i.e., based on the principles related to basic unit 401 in FIG. 4A) may provide various advantageous features. The purity of the spectral separation between the filter pass-bands may be altered by changing the number of iterations of the basic unit structure. An elegant aspect of this approach may be that changing the layer thickness by a constant factor may allow two mutually distinct sets of filter transmission pass-bands. Compared to other efforts in implementing thin-film optical interference filters, these advantageous features may contribute to relatively lower costs of implementation.

Other exemplary embodiments of spectral means 201 may include other types of thin-film optical interference filters, other types of optical interference filters (e.g., based on holographic film), optical absorption filters, optical comb filters, diffraction gratings, and combinations of these various techniques. Each technique may provide pass-bands that that may be similar to the pass-bands of basic unit 401 in FIG. 4A.

Another exemplary type of thin-film optical interference filter may operate according to slightly different designs. FIG. 4A shows a basic unit 401 with each layer having one of four candidate thicknesses. In contrast, one may design a basic unit with each layer having one of only two candidate thicknesses. Such a stacking design may comprise the following pattern: a TiO₂ layer of thickness A, a SiO₂ layer of thickness B, a TiO₂ layer of thickness A, a SiO₂ layer of thickness B, etc.

In the above description related to FIGS. 4A-4D, an exemplary embodiment of spectral means 201 may include thin-film interference filter teachings. Such filter teachings exemplify techniques involving subtraction of undesired spectral content from an input spectrum. The remaining spectral content may be located within desired sets of spectral bands. However, other techniques may provide the same spectral content located within the same desired sets of spectral bands. Some techniques may include addition of desired spectral content so that added spectral content may be located within the same desired sets of spectral bands.

Embodiments of spectral means 201 using such additive techniques may incorporate light sources, e.g., light-emitting diodes (LEDs), lasers, gas discharge lamps, any narrowband light source. Among LEDs, examples may include inorganic (crystalline) LEDs, organic LEDs (OLEDs), and quantum dot LEDs.

Light sources according to embodiments of the invention may have specific spectral characteristics. For instance, the light sources may provide emission bands of light having spectral content within desired sets of spectral bands, such as the exemplary spectral bands in FIG. 2A.

In embodiments with additive techniques, presenting stereoscopic images may involve light sources providing sets of emission bands of light, e.g., left-eye emission bands and right-eye emission bands. The sets of emission bands may include spectral content within desired sets of spectral bands, e.g., left-eye spectral bands and right-eye spectral bands. For example, presenting stereoscopic images may involve sequentially switching the appropriate left and right sets of emission bands, synchronous with displaying images for left and right images. When viewed through an appropriate multi-spectral viewing means, stereoscopic images may be presented to the viewer. The left and right sets of emission bands may also be presented simultaneously.

An exemplary light source may generate an emission band of light that is similar in width to the width of a desired spectral band. For an exemplary spectral band with a width of 30 nm, an exemplary LED may have a full width at half maximum (FWHM) around 30 nm.

Light source selection may be based on the spectral characteristics of desired spectral bands. For an exemplary spectral band centered at 450 nm, an LED with a center wavelength around 450 nm may be selected.

Variations may include modification of emission bands. If an emission band is greater in width (e.g., a base with a wide spectral width at lower amplitudes) than the width of a desired spectral band, subtractive techniques may be used to remove undesired spectral content (e.g., filtering to narrow the base). If an emission band is narrower in width than the width of a desired spectral band (e.g., a narrow spectral linewidth), additive techniques may be used to provide additional spectral content (e.g., adding light sources).

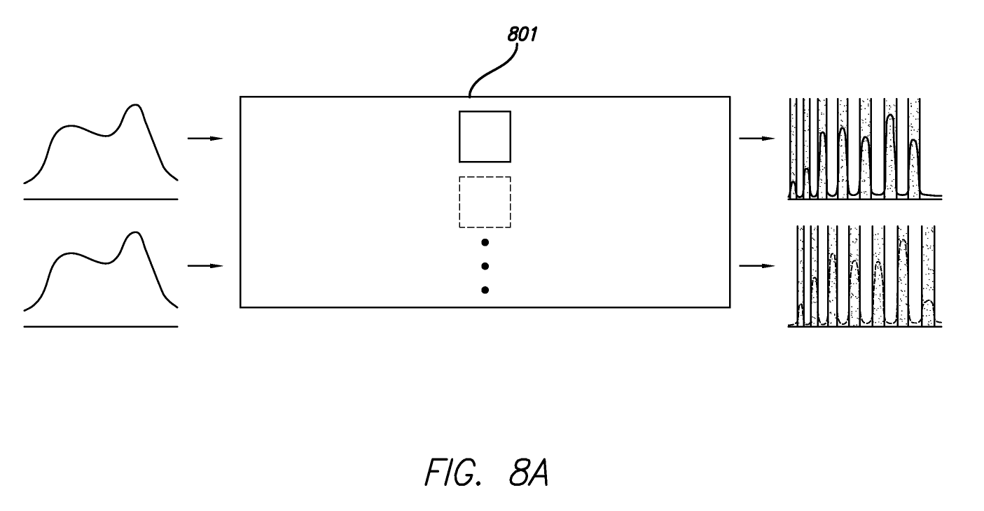

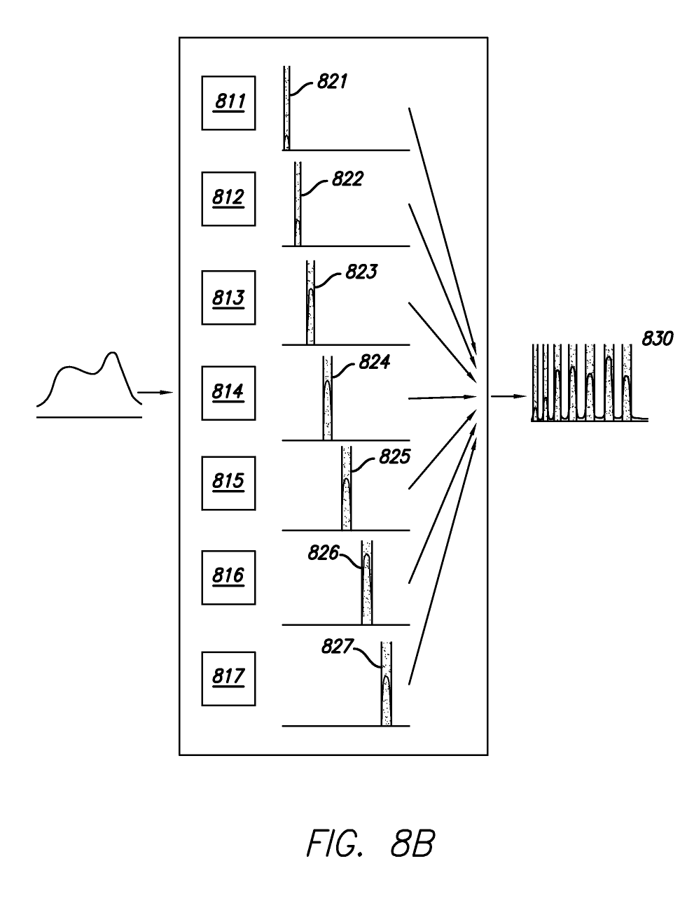

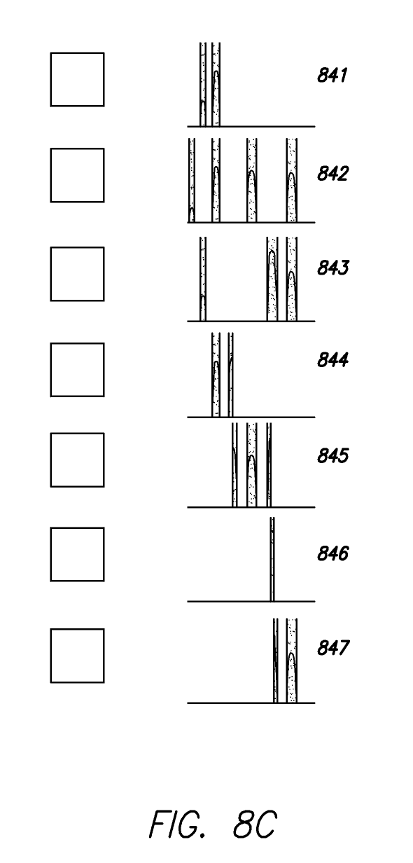

FIG. 8A illustrates an exemplary multi-spectral illuminant embodiment. In accordance with the spectrum of a left-eye image, one or more light sources may be used to provide emission bands of light including spectral content within the left-eye spectral bands. Corresponding processes may apply for right-eye aspects. A multi-spectral illuminant 801 may comprise one or more light sources for left image lighting, one or more light sources for right image lighting, or one or more light sources for both left and right image lighting.

In some embodiments, one light source may provide multiple emission bands (e.g., a multiple-wavelength LED). The emission bands may be periodically repeating. The emission bands may be irregularly spaced. In some embodiments, one light source may switch between multiple sets of emission bands, e.g., a left-eye set of emission bands and a right-eye set of emission bands.

FIG. 8B illustrates details of an example variation of a multi-spectral illuminant embodiment having multiple light sources 811-817. Each light source may generate an emission band of light corresponding to a spectral band 821-827. Different emission bands can be combined together to form the output set of emission bands 830.

FIG. 8C illustrates exemplary variations of light sources of a multi-spectral illuminant embodiment. A light source may generate multiple emission bands with spectral content within one or more desired spectral bands (as exemplified in set 843). The emission bands may occur in desired spectral bands that are adjacent (as exemplified in set 841) or non-adjacent (as exemplified in set 842). An emission band may fill all or part of a desired spectral band (as exemplified in sets 844-847).

Spectral means 201 may be embodied in environments for stereographic displays, such as projecting apparatuses, flat-screen displays, televisions, computer monitors, picture frames, hand-held viewing devices, head-mounted displays, vision testing equipment, etc. For example, the thin-film optical interference filter discussed above (i.e., based on the principles related to basic unit 401 in FIG. 4A) may be applied as thin-film coatings on suitable surfaces in the path of the projector light beam of a movie projector. Such surfaces may be internal or external to the movie projector. For another example, the multi-spectral illuminant teachings discussed above may be used in the illuminant of a movie projector or in the backlight of a liquid crystal display (LCD), as used in large screen televisions and computer monitors.

Viewing Means

In FIG. 2A, images 250 and 260 are viewed through viewing means 202. As noted above, viewing means 202 may present at least some of the spectral content contained in the spectral bands of set 233 to the left eye of a viewer through spectrum 271. Viewing means 202 may also prevent the presentation of most or all of the spectral content contained in the spectral bands of set 243 to the left eye of the viewer. Corresponding processes may apply for the right-eye aspects of viewing means 202.

An exemplary embodiment for such a viewing means 202 may include optical spectral filters, such as optical interference filters and optical absorption filters. Among optical interference filters, examples may include thin-film interference filters and holographic interference filters. More specifically, a thin-film interference filter with dielectric layers may be employed. Even more specifically, a thin-film optical interference filter, as described above and with reference to basic unit 401 of FIG. 4A, may be employed.

With reference to FIG. 2A, viewing means 202 may comprise a viewing filter for left-eye image 250 and a viewing filter for the right-eye image 260. In the case of a display 203 that does not significantly alter the spectral content or location of the spectral content contained in the spectral bands of set 233, there may be a complete or substantial overlap between the spectral bands of set 233 with the pass-bands of the viewing filter for left-eye image 250. Spectral content in such overlapping portions could pass through the viewing filter to the viewer's left eye. Corresponding principles may apply to the viewing filter for the right-eye aspects of the system.

In the case that display 203 does significantly alter the spectral content or location of the spectral content contained in the spectral bands of set 233, the pass-bands of the viewing filter may be adjusted to account for this alteration. Proper adjustment may allow desired spectral content to pass through the viewing filter to the viewer's left eye despite the alteration of spectral content by the display 203. Corresponding principles may apply for the right-eye aspects of the system.

The left-eye and right-eye viewing filters may have different transmission spectrums to correspond to the differences between set 233 and set 243. In order to provide the different transmission spectrums, one filter may serve as a base filter. The other filter may be created by shifting the location of its pass-bands relative to the base filter. This effect may be achieved by incrementing each of the layer thicknesses of each of the basic units of the base filter by a constant factor. As standing wave wavelengths may be related to layer thicknesses, change in layer thicknesses may lead to change in the location of the filter pass-bands.

As discussed above, this type of thin-film optical interference filter (i.e., based on the principles related to basic unit 401 in FIG. 4A) may provide various advantageous features. The purity of the spectral separation between the filter pass-bands may be altered by changing the number of iterations of the basic unit structure. An elegant aspect of this approach may be that changing the layer thickness by a constant factor may allow two mutually distinct sets of filter transmission pass-bands. Compared to other efforts in implementing thin-film optical interference filters, these advantageous features may contribute to relatively lower costs of implementation.

Other exemplary embodiments of viewing means 202 may include other types of thin-film optical interference filters, other types of optical interference filters (e.g., based on holographic film), optical absorption filters, and combinations of these various techniques. Each technique may provide pass-bands that may be similar or different from the pass-bands of basic unit 401 in FIG. 4A. The final output of an exemplary viewing means 202 may provide images with spectral bands that follow the principles discussed above regarding images with neutral and similar color balances.

Viewing means 202 may be embodied in various environments including, but not limited to, traditional eyeglasses (i.e., those with or without frames that either rest upon the nose and/or ears or wrap all or partially around the head), sunglasses, contact lenses, helmet visors or other visors or shields, other eyewear, masks, vision testing equipment, hand-held viewing devices, other arrangements independently supported and located between the viewer's eyes and the viewing display space, or any other technique where it would be possible to separate images for each eye. For example, the thin-film optical interference filter discussed above (i.e., based on the principles related to basic unit 401 in FIG. 4A) may be applied as thin-film coatings on suitable surfaces, such as lens surfaces, of 3D glasses for viewing stereographic motion pictures in a movie theater. For another example, glasses with such thin-film coatings may also function as ordinary sunglasses due to characteristics similar to ordinary sunglasses, e.g., provision of left-eye and right-eye images with neutral and similar color balances.

Projection Embodiments with Spectral Filters

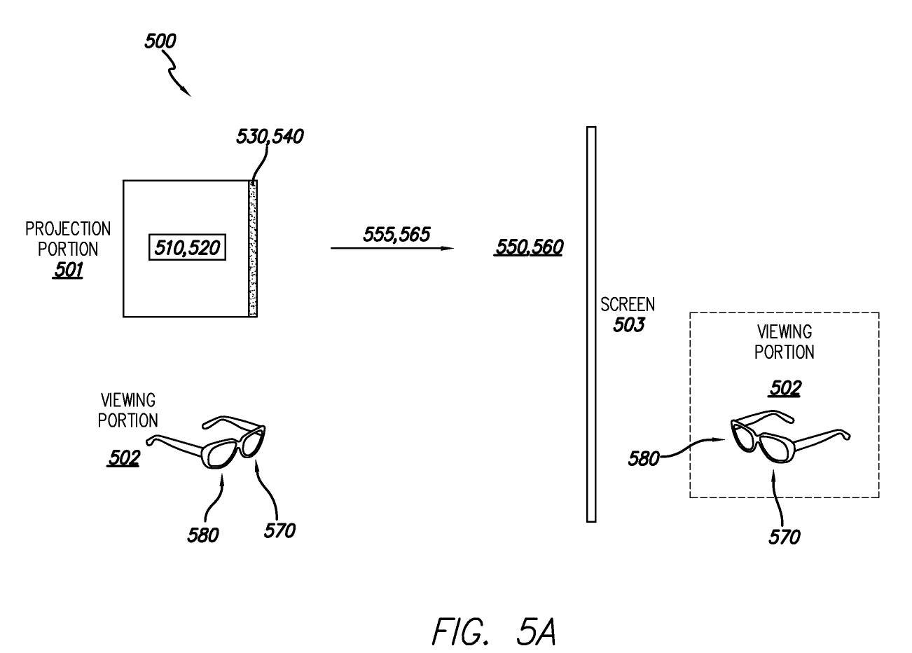

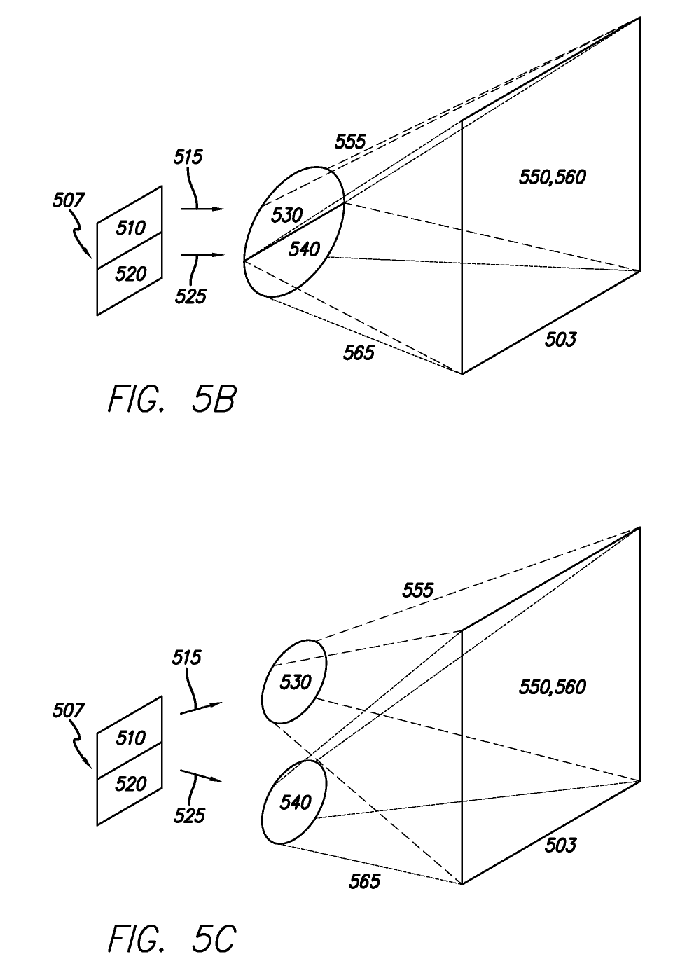

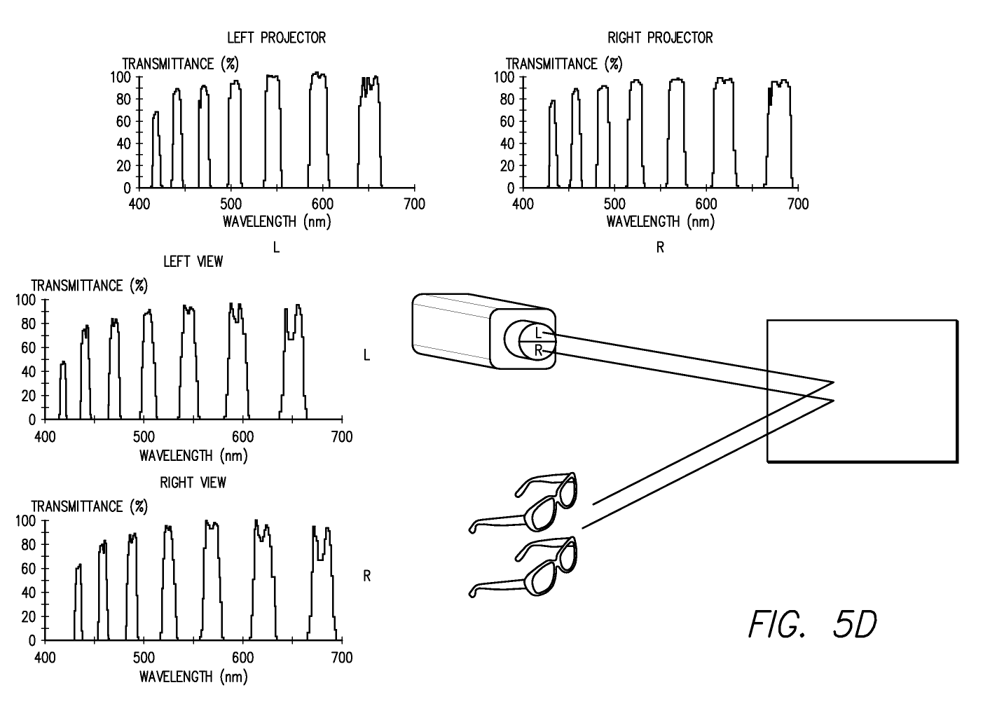

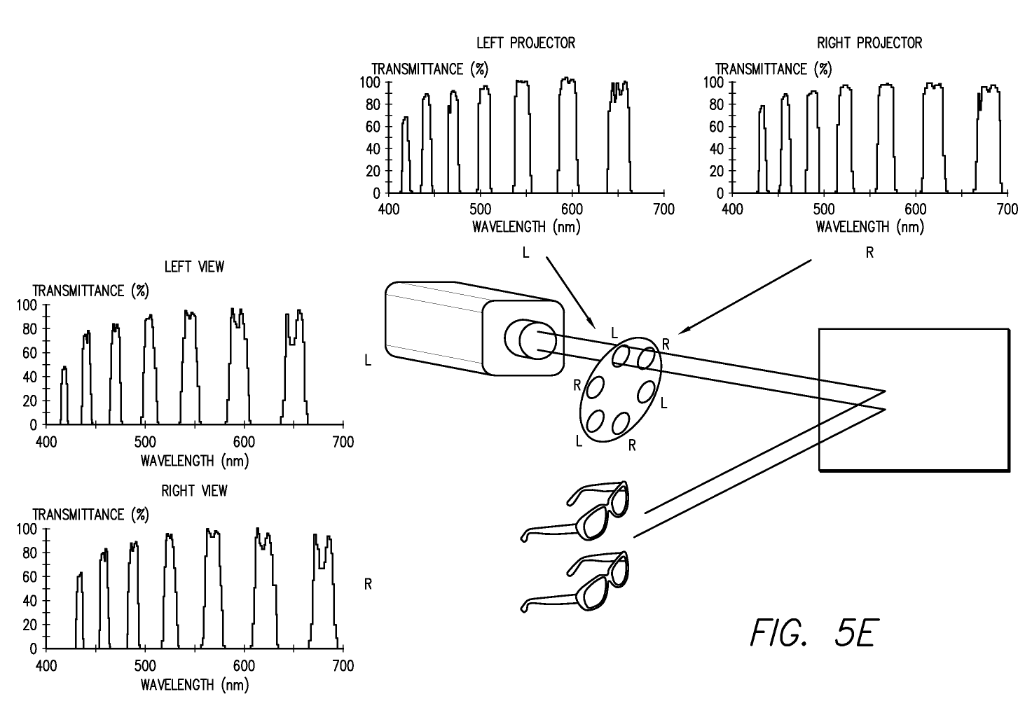

FIG. 5A illustrates an exemplary projection embodiment of a multi-spectral stereographic display according to various embodiments of the invention. The example embodiment of FIG. 5A includes a projection portion 501, a screen 503, and a viewing portion 502. Projection portion 501 may include two filters 530 and 540, and filters 530 and 540 may correspond to spectral means 201 in FIG. 2A. Two sets of images can be projected through filters 530 and 540. A first set 510 may comprise images for the visual perspective of the left eye, and a second set 520 may comprise images for the visual perspective of the right eye. The images of set 510 may correspond to image 210 in FIG. 2A. The images of set 520 may correspond to image 220 in FIG. 2A.

Light carrying the set of images 510 may pass through filter 530. This filtered light 555 may carry a set of filtered images 550 and may be projected onto screen 503 by a projector as a spectrum presenter. Light carrying the set of images 520 may pass through filter 540. This filtered light 565 may carry a set of filtered images 560 and may be also projected onto screen 503 by the projector as the spectrum presenter. Filtered images 550 and filtered images 560 may be alternately displayed in time.

There may be variable aspects of projection portion 501. For example, left-eye and right-eye images may be simultaneously displayed on screen 503. The projection filters may be transmission filters, reflection filters, or combinations of these types of filters as discussed above to provide various arrangements of directing light beams. Additionally, the filters may be spatially moved to intersect light beams, as illustrated in the example system of FIG. 5E with the rotating filter wheel. The rotation of the filter wheel may be synchronized with alternating left-eye and right-eye images so that left-eye images are filtered by a left-eye filter and right-eye images are filtered by a right-eye filter.

Other variations may involve the number of projector outputs. The images may be projected onto screen 503 by a single-projector embodiment, as in FIG. 5B. Images of set 510 may be stored on a storage medium 507, such as film or digital image capture media. Light 515 carrying the set of images 510 may be directed through filter 530. This filtered light 555 may carry a set of filtered images 550 and may be projected onto screen 503. Images of set 520 may also be stored on storage medium 507, such as film or digital image capture media. Light 525 carrying the set of images 520 may be directed through filter 540. This filtered light 565 may carry a set of filtered images 560 and may be projected onto screen 503. Filtered light 555 and filtered light 565 may be projected from a single projector output in this “over-under” configuration. FIG. 5D illustrates a system view of an example system with a single-projector embodiment including an “over-under” configuration.

Another embodiment may include a dual-projector embodiment, as in FIG. 5C. In contrast to FIG. 5B, filtered light 555 and filtered light 565 may be respectively projected from two respective projector outputs.

A viewer at viewing portion 502 may view screen 503 through a viewing device as a spectrum viewer with a filter 570 for the left eye and a filter 580 for the right eye. The purpose of the left eye filter 570 would be for viewing filtered images 550 with the left eye while preventing viewing of filtered images 560 by the left eye. In corresponding fashion, the purpose of the right eye filter 580 would be for viewing filtered images 560 with the right eye while preventing viewing of filtered images 550 by the right eye. Therefore, the left eye may substantially or preferably exclusively see filtered images 550 for the visual perspective of the left eye, and the right eye may substantially or exclusively see filtered images 560 for the visual perspective of the right eye. Thus, the viewer may experience stereo vision as described above. Some embodiments may involve employing a viewing portion on the same side of screen 503 as projection portion 501. Other embodiments may involved employing a viewing portion on the other side of screen 503, as indicated by the multiple locations of a viewing portion 502 in FIG. 5A.

The embodiments described above do not require the maintenance of polarization and therefore can be used with a diffuse white surface such as the projection screens found in the majority of the world's cinemas. Although in such an embodiment, no special screen material is required as in polarization systems, this system can, in other embodiments, work with metallic-surface projection screens.

Also in FIG. 5A; the implementation of optical filters with dielectric reflectors to create multiple standing waves can enable the visible spectrum to be separated into two separate and mutually exclusive sets of spectral bands, wherein originally neutral spectral content apportioned into each set would be perceived as neutral for its corresponding eye. For example, light of each set of spectral bands can appear to the eye as white light. Therefore, a full-color image can be presented to each eye without the necessity of modifying the color balance of the original image content.

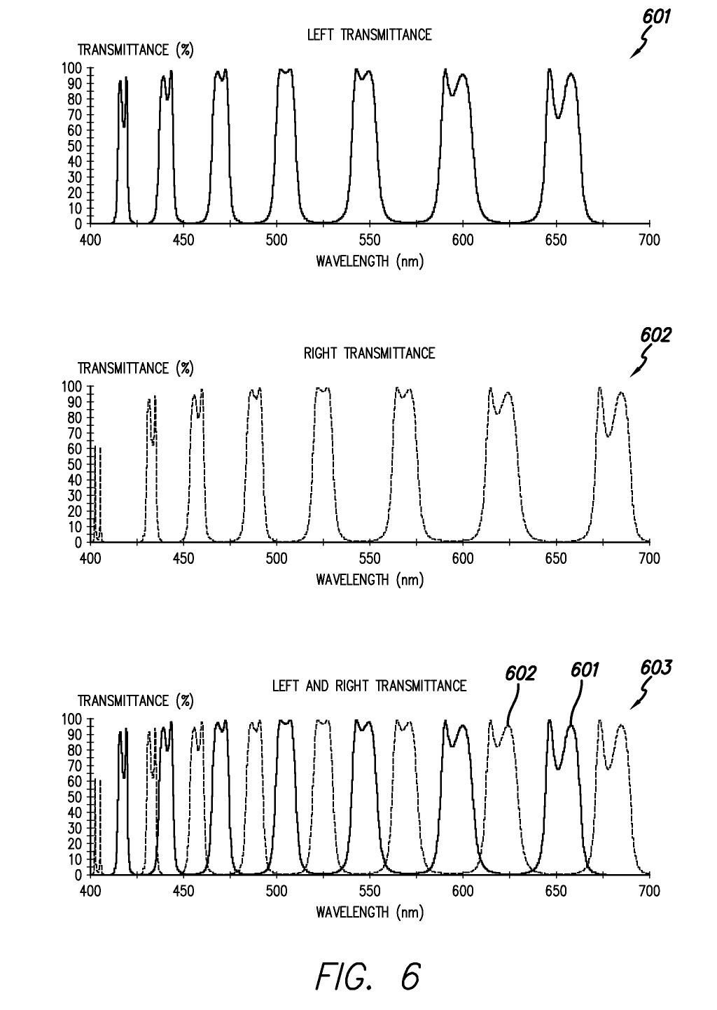

FIG. 6 illustrates the representative operation of exemplary filters in FIG. 5A, according to the thin-film optical interference filter discussed above (i.e., based on the principles related to the basic unit 401 in FIG. 4A). Top spectrum 601 may represent the exemplary operation of a left-eye image filter. Middle spectrum 602 may represent the exemplary operation of a right-eye image filter. Bottom spectrum 603 illustrates an overlay of the two exemplary spectrums above.

Using such filters may take advantage of natural band resonances (e.g., natural band harmonics) in order to make a high-performance multi-spectral projection embodiment where the driving factor in the design is the simplicity of producing the viewing filters, leaving the relatively more complex filtering to the projection filters. In other words, a particular level of quality in an exemplary stereographic display system may involve a corresponding total level of filtering quality. For example, in some embodiments, the total number of basic units for each eye may be nine. In such embodiments, a projection filter may comprise a relatively more complex filter of 6 basic units, while the corresponding viewing filter may comprise a relatively simple filter of 3 basic units. More specifically, a first projection filter for a first eye may comprise 6 basic units, each unit based on the parameters of Table A, and a second projection filter for a second eye may comprise 6 basic units, each unit based on the parameters of Table B. A first viewing filter corresponding to the first eye may comprise 3 basic units, each unit based on the parameters of Table A. A second viewing filter corresponding to the second eye may comprise 3 basic units, each unit based on the parameters of Table B. The first and second projection filters may exhibit characteristics similar or identical to the filter characteristics shown in FIGS. 3A and 3C. The first and second viewing filters may exhibit characteristics similar or identical to the filter characteristics shown in FIGS. 3A and 3C.

Other considerations for a relatively more complex projection filter may involve more sophisticated control processes and with finer engineering tolerances. Computer refinements may provide higher levels of precision and fine tuning. The pass-bands of projection filter may be more finely shaped than the pass-bands of a viewing filter. Such considerations for a projection filter may lead to various filter features (e.g., improved light transmission within the pass-bands and steeper cut-off edges of pass-bands, as shown in FIGS. 5D and 5E) and greater filter complexity. With relatively greater filter complexity in a projection filter, an exemplary projection embodiment may provide satisfactory stereo vision experiences with a relatively simpler viewing filter.

Accordingly, the projection embodiment of FIG. 5A relates to a multi-spectral stereoscopic system that may not rely on polarization techniques for display and can be viewed using inexpensive glasses that can be mass-produced using inexpensive glass or polymer substrates.

In order to minimize unit cost of the viewing glasses, in some embodiments, the viewing portion can comprise a coating on a plastic polymer substrate manufactured with a slight curvature and in a simple form to facilitate reliable volume production. The viewing filters can be produced from a wide variety of dielectric materials by physical vapor deposition including thermal and electron beam techniques, as well as sputtering or other techniques. These processes can be enhanced with other techniques including ion assistance to improve film deposition. Examples of materials can include, but are not limited to, Nb₂O₃, ZnS, TiO₂, etc. for a high “n” material, and SiO₂, 3NaFAlF₃, MgF₂, etc. for the low “n” material. Due to the relative simplicity of utilizing the standing wave effect, material choice or process control can be relatively simple and therefore simple to implement. For example, resource and cost constraints may lead one to choose from three high “n” materials and just one low “n” material.

In a projection system of the disclosed embodiments, a projection filter can be made of the same materials as those employed in the glasses, although the heat of the projector may necessitate a refractory oxide to avoid melting or other physical or chemical degradation due to the high temperatures (e.g., Nb₂O₃, TiO₂, etc.). This extra material feature, along with making the projection filters as complex and refined as needed to function optimally with the viewing filters, if all done in an optimized production process, can allow the system not only to produce a pleasant stereoscopic viewing experience with minimal eye strain, but can also allow the product to be implemented on a mass-production basis since the cost of the viewing optics is one of the main impediments to any stereoscopic viewing system becoming widely utilized.

Backlight Embodiments with Spectral Filters

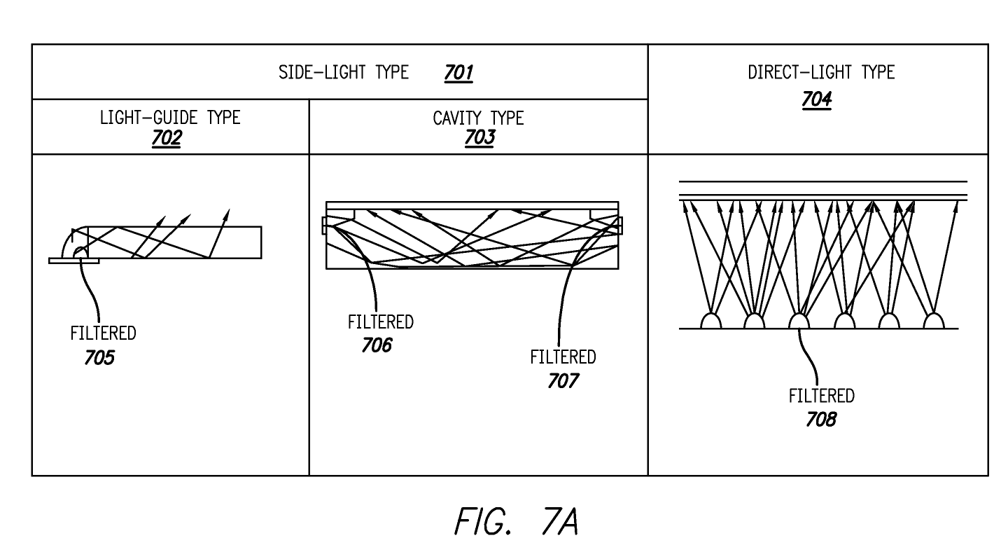

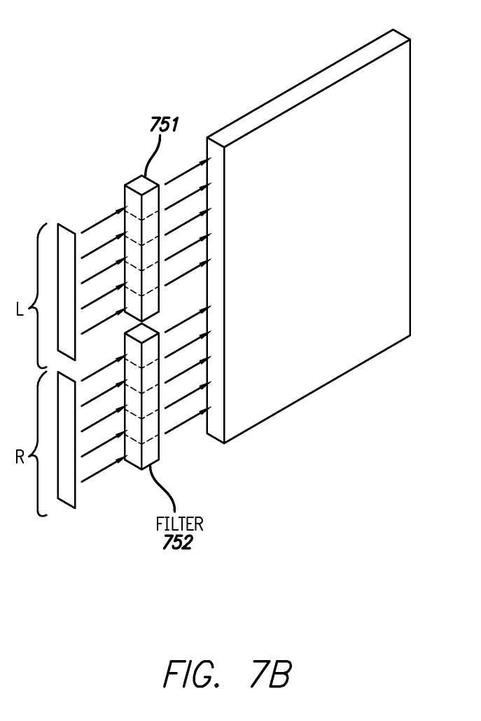

FIG. 7A illustrates exemplary inventive backlight embodiments with spectral filters. FIG. 7A shows different types of structures of backlights for LCDs: edge-lit (or side-light type 701 including light-guide type 702 and cavity type 703) and direct-lit (or direct-light type 704) backlights. Multi-spectral light may be introduced in the backlight structures by one or more illuminants 705-708 filtered by spectral filters. These spectral filters may correspond to spectral means 201 in FIG. 2A.

FIG. 7B illustrates an example inventive edge-lit backlight embodiment with spectral filters. The example embodiment of FIG. 7B may be similar to the projection embodiment of FIG. 5A with some differences. For instance, instead of a projection portion, FIG. 7B shows a lighting portion. The lighting portion may include one or more light sources for providing “white,” or achromatic, light. Examples of such light sources may include any general “white” light source, such as a tungsten lamp, a fluorescent lamp, gas lamps, and various LED configurations (including multi-element LED configurations and configurations with OLEDs).

The lighting portion may also include two lighting filters 751 and 752 corresponding to spectral means 201 in FIG. 2A. Each filter may be embodied as: a comb filter, a parallel array of adjacent band-pass filters, a serial array of notch filters, or a combination of these types of filters.

Applications of the example embodiments of FIGS. 7A-7B may employ LEDs in stereoscopic video displays in LCD display systems. The illuminant sources for LCD backlights may include these LEDs.

In some backlight embodiments, presenting stereoscopic images may involve sequentially switching the appropriate filtered light for the backlight, synchronous with displaying images for left and right images. The left image display rate may be 60 frames per second, and the right image display rate may be 60 frames per second. The combined image display rate may be 120 frames per second. Left and right images may be interleaved in sequence, and embodiments with LEDs may switch between lighting left and right images within 20-50 ns. When viewed through an appropriate multi-spectral viewing means, stereoscopic images may be presented to the viewer.

There may be variable aspects of the lighting portion. For example, left-eye and right-eye images may be simultaneously displayed on the display. The lighting filters may be transmission filters, reflection filters, or combinations of these types of filters to provide various arrangements of directing light beams. Additionally, the filters may be spatially moved to intersect light beams, as with a rotating filter wheel. The rotation of the filter wheel may be synchronized with alternating left-eye and right-eye images so that left-eye images are filtered by a left-eye filter and right-eye images are filtered by right-eye filter.

Projection Embodiments with Multi-Spectral Illuminants

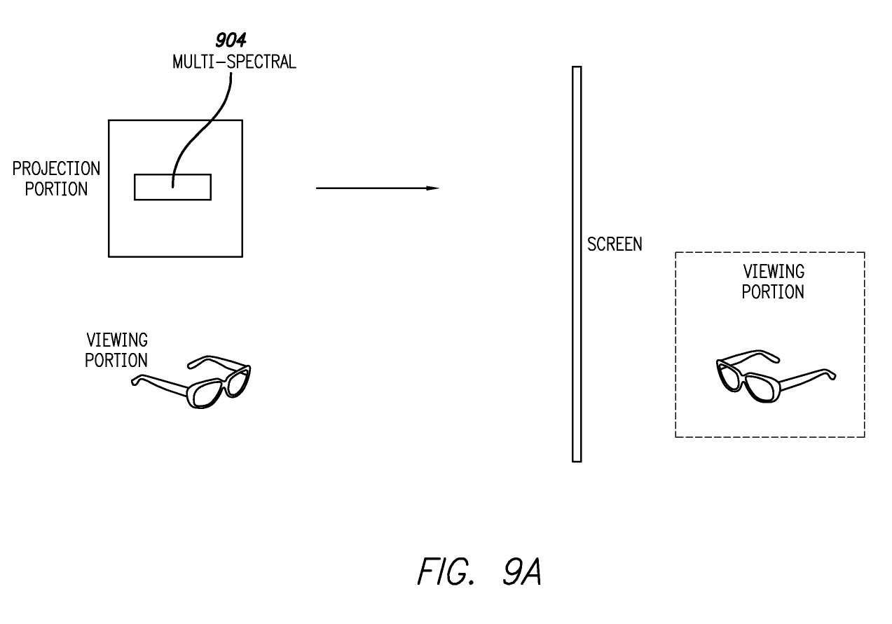

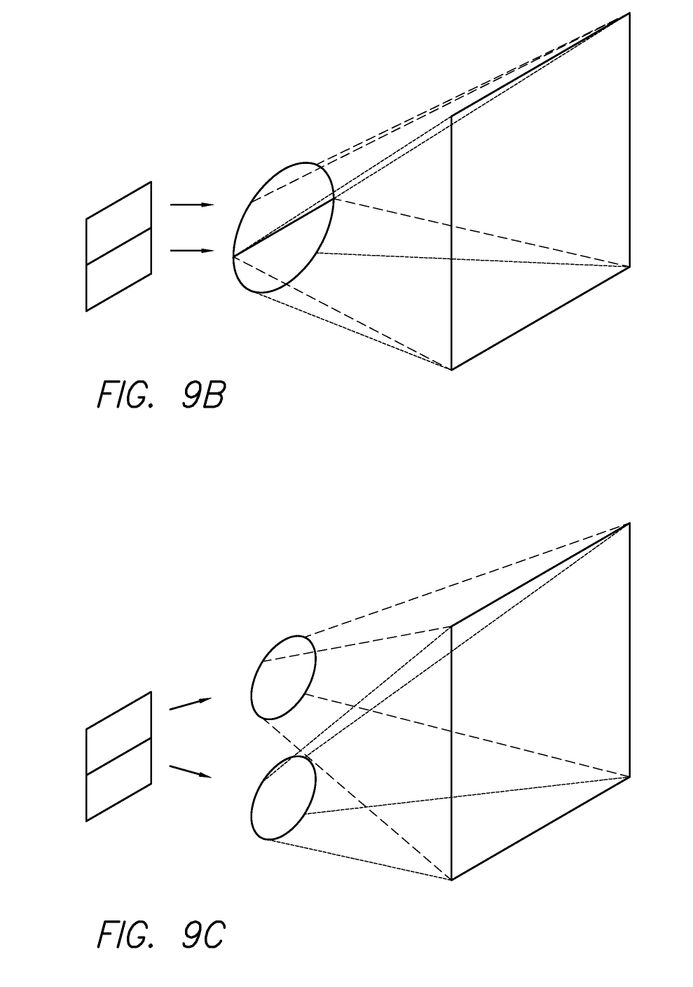

FIG. 9A illustrates an example inventive projection embodiment with a multi-spectral illuminant. The example embodiment of FIG. 9A may be similar to the projection embodiment of FIG. 5A with some differences. For instance, FIG. 9A shows a multi-spectral illuminant 904, which can incorporate the teachings related to FIGS. 8A-8C above. Light from one or more multi-spectral illuminants may carry the images. The one or more multi-spectral illuminants may correspond to spectral means 201 in FIG. 2A.

An application of the example embodiment of FIG. 9A may employ high-powered LEDs in a stereoscopic projection system. The illuminant source for a projector may include these LEDs. Display spaces for projected light could include a movie screen, transmissive LCDs, reflective LCDs, and reflective micro-mirror displays.

Variations may also include optional filters for shaping the emission bands of the one or more multi-spectral illuminants. Optional filters may be located along a light propagation path for light from the one or more multi-spectral illuminants. Such filters may be embodied as: comb filters, band-pass filters, notch filters, low-pass filters, high-pass filters, or a combination of these types of filters.

Variations applicable to the projection embodiments with spectral filters of FIG. 5A-5E may apply to projection embodiments with a multi-spectral illuminant. Left-eye images and right-eye images may be simultaneously or alternately displayed in time. Variations with projection filters may use transmission filters, reflection filters, or combinations of these types of filters to provide various arrangements of directing light beams. Additionally, the filters may be spatially moved to intersect light beams, as illustrated in the example system of FIG. 5E with a rotating filter wheel. The rotation of the filter wheel may be synchronized with alternating left-eye and right-eye images so that left-eye images are filtered by a left-eye filter and right-eye images are filtered by a right-eye filter. Other variations may involve the number of projector outputs. Similar to FIG. 5B, FIG. 9B illustrates a single-projector embodiment of FIG. 9A. Similar to FIG. 5C, FIG. 9C illustrates a dual-projector embodiment of FIG. 9A.

Backlight Embodiments with Multi-Spectral Illuminants

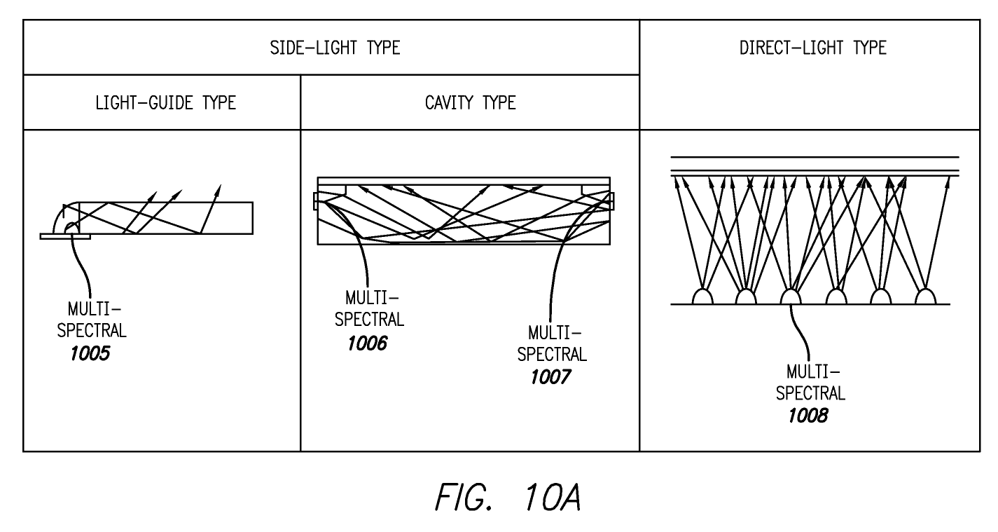

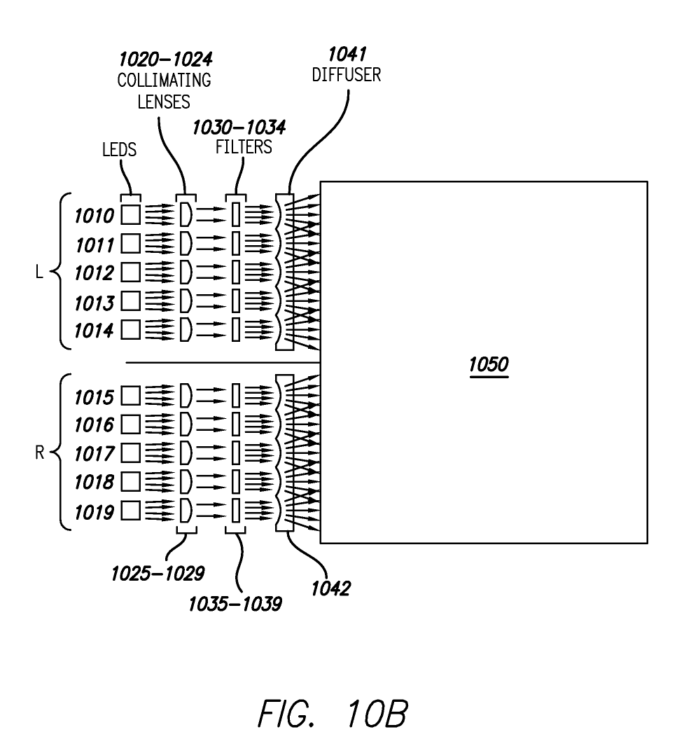

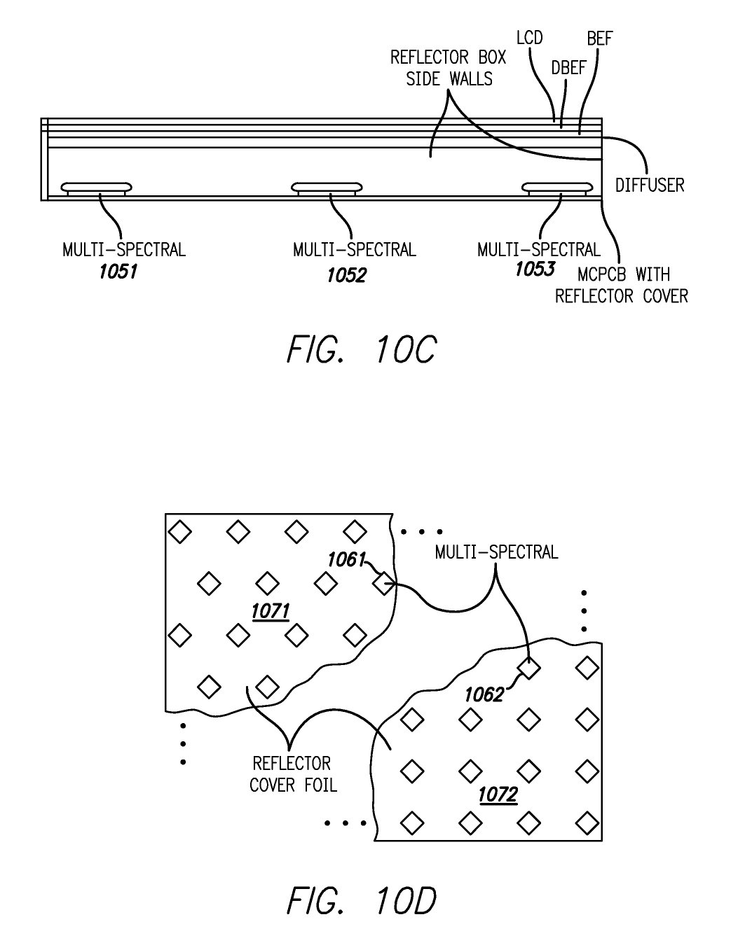

FIG. 10A illustrates exemplary inventive backlight embodiments with multi-spectral illuminants. The example embodiments of FIG. 10A may be similar to the backlight embodiments of FIG. 7A. However, the example embodiments of FIG. 10A may employ multi-spectral illuminants 1005-1008, which can incorporate the teachings related to FIGS. 8A-8C above. Multi-spectral light may be introduced in the backlight structures by one or more multi-spectral illuminants. The one or more multi-spectral illuminants may correspond to spectral means 201 in FIG. 2A.

FIG. 10B illustrates an example inventive edge-lit backlight embodiment with multi-spectral illuminant techniques. The example embodiment of FIG. 10B may be similar to the backlight embodiment of FIG. 7B with some differences. For instance, instead of any general “white” light source, FIG. 10B shows multi-spectral illuminant techniques according to the teachings related to FIGS. 8A-8C above. FIG. 10B shows a lighting portion with five LED light sources 1010-1014 for left image lighting and five LED sources 1015-1019 for right image lighting. The multiple LED light sources may introduce multi-spectral light into a backlight panel 1050 through optional components, e.g., collimating lenses 1020-1029, filters 1030-1039, and diffusers 1041-1042.

FIG. 10C illustrates an example inventive direct-lit backlight embodiment with multi-spectral illuminants. FIG. 10C shows a lighting portion with multi-spectral illuminants 1051-1053, which can incorporate the teachings related to FIGS. 8A-8C above.

FIG. 10D illustrates variations of arrangements of multi-spectral illuminants in an example inventive direct-lit backlight embodiment. The multi-spectral illuminants (as exemplified by 1061-1062) can incorporate the teachings related to FIGS. 8A-8C above. One arrangement 1071 has a hexagonal pattern, and another arrangement 1072 has a rectangular pattern. A multi-spectral illuminant may comprise one or more light sources for left image lighting, one or more light sources for right image lighting, or one or more light sources for both left and right image lighting.

Applications of the example embodiments of FIGS. 10A-10D may employ LEDs in stereoscopic video displays in LCD display systems. The illuminant sources for LCD backlights may include these LEDs.

In some backlight embodiments, presenting stereoscopic images may involve sequentially switching the appropriate filtered light for the backlight, synchronous with displaying images for left and right images. The left image display rate may be 60 frames per second, and the right image display rate may be 60 frames per second. The combined image display rate may be 120 frames per second. Left and right images may be interleaved in sequence, and embodiments with LEDs may switch between lighting left and right images within 20-50 ns. When viewed through an appropriate multi-spectral viewing means, stereoscopic images may be presented to the viewer.

Variations may also include optional filters for shaping the emission bands of the one or more multi-spectral illuminants. Optional filters may be located along a light propagation path for light from the one or more multi-spectral illuminants. Such filters may be embodied as: comb filters, band-pass filters, notch filters, low-pass filters, high-pass filters, or a combination of these types of filters.

Variations applicable to the backlight embodiments with spectral filters of FIG. 7A-7B may apply to backlight embodiments with multi-spectral illuminant teachings. Left-eye images and right-eye images may be simultaneously or alternately displayed in time. Variations with lighting filters may use transmission filters, reflection filters, or combinations of these types of filters to provide various arrangements of directing light beams. Additionally, the filters may be spatially moved to intersect light beams, as with a rotating filter wheel. The rotation of the filter wheel may be synchronized with alternating left-eye and right-eye images so that left-eye images are filtered by a left-eye filter and right-eye images are filtered by a right-eye filter.

Arrangements of Spectral Bands

FIG. 2A, described above, presents only one exemplary arrangement of spectral bands. However, other exemplary arrangements are possible, as shown by the arrangement of spectral band sets 235 and 245 and the arrangement of spectral bands sets 236 and 246 in FIG. 2B.

FIG. 2A shows seven spectral bands of set 233 spectrally interleaving with seven spectral bands of set 243. However, other exemplary arrangements may comprise greater or fewer spectral bands for each of set 233 and set 243, such as five or nine spectral bands for each set. Additionally, the number of spectral bands for each set does not have to match; other combinations may include more spectral bands in one set and less in the other set. In order to provide images with high quality neutral color balance, the number of spectral bands for each set may be greater than the number of unique color receptors in the viewer.

In FIG. 2A, the spectral bands of set 233 may spectrally interleave with the spectral bands of set 243. For example, spectral bands of set 233 may be the odd wavelengths within a range of wavelengths with spectral bands of set 243 at even wavelengths within the same range. Set 233 and set 243 do not require spectral bands at specifically located wavelengths, such as the specific location of spectral bands at specifically red, green, and blue portions of the electromagnetic spectrum visible to the human eye. Accordingly, set 243 and set 233 may be shifted in wavelength to suitable variations in location within an operating range of the electromagnetic spectrum.

FIG. 2C illustrates various ways to modify spectral content of a spectral band. The spectral content of a spectral band may be modified in multiple aspects, such as amplitude 291, width 292, and location 293. Such modifications may provide various ways for adjusting the color balancing of the multi-spectral spectrums of the various inventive embodiments. For instance, such modifications may enable adjustment of white point location.

Amplitude modifications may be embodied via attenuators, trimming filters, amplifiers, light source modulation (e.g., via pulse width modulation), etc. Width modifications may be embodied via trimming filters, band-pass filters, notch filters, light source selection, etc. Location modifications may be embodied via light source selection, filter selection, filter composition, etc.

FIG. 6 shows the spacing of pass-bands according to the natural resonance characteristics (e.g., natural band harmonics) of an exemplary embodiment of a thin-film optical interference filter discussed above (i.e., based on the principles related to basic unit 401 in FIG. 4A). However, the spectral bands may be spaced in other exemplary arrangements. For example, the spacing may be at regular intervals (e.g., every 20 nm) or various irregular intervals.

Alternate Uses and Other Variations

Alternate uses of the disclosed embodiments can include static image viewing or for the projection and viewing of CAD models or in medical imaging. Variations of the system can include variations of the exact spectral bands that are used and the incorporation of band-shaping of the projection filters to compensate for spectral defects in the light source to enable correct color balancing. Variations could be developed to work with digital TV where the light engine produces two or more images within an image recognition period.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A multi-spectral stereographic display apparatus comprising:
a first spectral filter apportioning portions of an operating spectral range of light into a first set of spectral bands, the first set of spectral bands including four or more spectral bands;
a second spectral filter apportioning portions of the operating spectral range of light into a second set of spectral bands, the second set of spectral bands including four or more spectral bands;
wherein the first set of spectral bands and the second set of spectral bands have low or no overlap with each other; and
wherein the spectral bands of the first set of spectral bands and the spectral bands of the second set of spectral bands alternate with each other.

2. The apparatus of claim 1, light of the first set of spectral bands stimulating a color sensation, light of the second set of spectral bands stimulating the same color sensation.

3. The apparatus of claim 2, the color sensation being the sensation of white light.

4. The apparatus of claim 3, incorporated into a projection system free of modifying the color balance of an original image content.

5. The apparatus of claim 1,
the first set of spectral bands having a first white point based on a reference illuminant;
the second set of spectral bands having a second white point based on the reference illuminant;
wherein the first white point is located within a discrimination space for low or no color difference and the second white point is located within the same discrimination space for low or no color difference.

6. The apparatus of claim 5, wherein the discrimination space is an achromatic discrimination space for neutral color.

7. The apparatus of claim 1, incorporated into a projection system free of any electronic processing that provides a color balance modification that compensates for differing color balances.

8. A multi-spectral stereographic display system comprising:
a projection portion including first and second projection filters apportioning portions of an operating spectral range of light into first and second sets of projection spectral bands, each of the first and second sets of projection spectral bands including four or more spectral bands, the first and second sets of projection spectral bands having low or no overlap with each other;
a viewing portion including first and second viewing filters apportioning portions of the operating spectral range of light into first and second sets of viewing spectral bands, each of the first and second sets of viewing spectral bands including four or more spectral bands, the first and second sets of viewing spectral bands having low or no overlap with each other;
wherein the first set of viewing spectral bands have at least some overlap with the first set of projector spectral bands;
wherein the second set of viewing spectral bands have at least some overlap with the second set of projector spectral bands;
wherein the spectral bands of the first and second sets of projection spectral bands alternate with each other; and
wherein the spectral bands of the first and second sets of viewing spectral bands alternate with each other.

9. The system of claim 8, light passed through the first projection filter and the first viewing filter stimulating a color sensation, light passed through the second projection filter and the second viewing filter stimulating the same color sensation.

10. The system of claim 9, the color sensation being the sensation of white light.

11. The system of claim 10, wherein the system is free of modifying the color balance of an original image content.

12. The system of claim 8,
the first and second sets of projection spectral bands having first and second projection white points based on a reference projection illuminant;
the first and second sets of viewing spectral bands having first and second viewing white points based on a reference viewing illuminant;
wherein the first projection white point is located within a discrimination space for low or no projection color difference and the second projection white point is located within the same discrimination space for low or no projection color difference; and
wherein the first viewing white point is located within a discrimination space for low or no viewing color difference and the second viewing white point is located within the same discrimination space for low or no viewing color difference.

13. The system of claim 12, wherein the discrimination space for low or no projection color difference or the discrimination space for no or low viewing color difference is an achromatic discrimination space for neutral color.

14. The system of claim 12, wherein the system is free of any electronic processing that provides a color balance modification that compensates for differing color balances.

15. The system of claim 8,
the projection portion configured for providing at least one pair of stereographic images through light carrying the at least one pair of stereographic images;
the viewing portion configured for receiving the at least one pair of stereographic images through the light carrying the at least one pair of stereographic images; and
the viewing portion configured for separating each of the stereographic images independent of any polarization of the light carrying the at least one pair of stereographic images.

16. A multi-spectral stereographic display method comprising:
apportioning portions of an operating spectral range of light into a first set of spectral bands, the first set of spectral bands including four or more spectral bands;
apportioning portions of the operating spectral range of light into a second set of spectral bands, the second set of spectral bands including four or more spectral bands;
wherein the first set of spectral bands and the second set of spectral bands have low or no overlap with each other; and
wherein the spectral bands of the first set of spectral bands and the spectral bands of the second set of spectral bands alternate with each other.

17. A multi-spectral stereographic display method comprising:
apportioning portions of an operating spectral range of light into a first set of projection spectral bands by a first projection filter,
apportioning portions of the operating spectral range of light into a second set of projection spectral bands by a second projection filter,
each of the first and second sets of projection spectral bands including four or more spectral bands,
the first and second sets of projection spectral bands having low or no overlap with each other;
apportioning portions of the operating spectral range of light into a first set of viewing spectral bands by a first viewing filter,
apportioning portions of the operating spectral range of light into a second set of viewing spectral bands by a second viewing filter,
each of the first and second sets of viewing spectral bands including four or more spectral bands,
the first and second sets of viewing spectral bands having low or no overlap with each other;
wherein the first set of viewing spectral bands have at least some overlap with the first set of projector spectral bands;
wherein the second set of viewing spectral bands have at least some overlap with the second set of projector spectral bands;
wherein the spectral bands of the first and second sets of projection spectral bands alternate with each other; and
wherein the spectral bands of the first and second sets of viewing spectral bands alternate with each other.

18. A multi-spectral stereographic display apparatus comprising:
a first spectral filter apportioning portions of an operating spectral range into a first set of spectral bands;
a second spectral filter apportioning portions of the operating spectral range into a second set of spectral bands;
wherein the first set of spectral bands and the second set of spectral bands have low or no overlap with each other; and
wherein the spectral arrangement of the first set of spectral bands corresponds to natural band harmonics.

19. The apparatus of claim 18, wherein the spectral arrangements of the first and second sets of spectral bands correspond to natural resonant characteristics of one basic unit structure type.

20. The apparatus of claim 18, each of the first and second sets of spectral bands comprising more bands than the number of types of color receptors in a target viewer.

21. The apparatus of claim 18, the first spectral filter incorporating band-shaping.

22. The apparatus of claim 18, the first spectral filter having a pass-band incorporating one or more modifications in amplitude, width, or location of an original pass-band.

23. A multi-spectral stereographic display system comprising:
a projection portion including first and second projection filters apportioning portions of an operating spectral range of light into first and second sets of projection spectral bands, the first and second sets of projection spectral bands having low or no overlap with each other;
a viewing portion including first and second viewing filters apportioning portions of the operating spectral range of light into first and second sets of viewing spectral bands, the first and second sets of viewing spectral bands having low or no overlap with each other;
wherein the first set of viewing spectral bands have at least some overlap with the first set of projector spectral bands;
wherein the second set of viewing spectral bands have at least some overlap with the second set of projector spectral bands; and
wherein the spectral arrangement of the first set of projection spectral bands and the spectral arrangement of the first set of viewing spectral bands correspond to natural band harmonics.

24. The system of claim 23, wherein the spectral arrangement of the first set of projection spectral bands and the spectral arrangement of the first set of viewing spectral bands correspond to natural resonant characteristics of one basic unit structure type.

25. The system of claim 23, each of the first set of projection spectral bands and the first set of viewing spectral bands comprising more bands than the number of types of color receptors in a target viewer.

26. The system of claim 23, the first projection filter incorporating band-shaping.

27. The system of claim 23, the first projection filter having a pass-band incorporating one or more modifications in amplitude, width, or location of an original pass-band.

28. The system of claim 23,
the first projection filter having a first set of projection pass-bands;
the first viewing filter having a first set of viewing pass-bands; and
the first set of projection pass-bands having steeper pass-band cut-off edges than the first set of viewing pass-bands.

29. A multi-spectral stereographic display method comprising:
apportioning portions of an operating spectral range of light into a first set of spectral bands;
apportioning portions of the operating spectral range of light into a second set of spectral bands;
wherein the first set of spectral bands and the second set of spectral bands have low or no overlap with each other; and
wherein the spectral arrangement of the first set of spectral bands corresponds to natural band harmonics.

30. A multi-spectral stereographic display method comprising:
apportioning portions of an operating spectral range of light into a first set of projection spectral bands by a first projection filter,
apportioning portions of the operating spectral range into a second set of projection spectral bands by a second projection filter,
the first and second sets of projection spectral bands having low or no overlap with each other;
apportioning portions of the operating spectral range into a first set of viewing spectral bands by a first viewing filter,
apportioning portions of the operating spectral range into a second set of viewing spectral bands by a second viewing filter,
the first and second sets of viewing spectral bands having low or no overlap with each other;
wherein the first set of viewing spectral bands have at least some overlap with the first set of projector spectral bands;
wherein the second set of viewing spectral bands have at least some overlap with the second set of projector spectral bands;
wherein the spectral arrangement of the first set of projection spectral bands and the spectral arrangement of the first set of viewing spectral bands correspond to natural band harmonics.

31. A multi-spectral stereographic display apparatus comprising:
a first spectral filter apportioning portions of an operating spectral range of light into a first set of spectral bands, light of the first set of spectral bands stimulating a color sensation;
a second spectral filter apportioning portions of the operating spectral range of light into a second set of spectral bands, light of the second set of spectral bands stimulating the same color sensation;
wherein the first set of spectral bands and the second set of spectral bands have low or no overlap with each other; and
wherein the first set of spectral bands and the second set of spectral bands are determined independently of RGB designation of spectral bands.

32. A multi-spectral stereographic display method comprising:
apportioning portions of an operating spectral range of light into a first set of spectral bands, light of the first set of spectral bands stimulating a color sensation;
apportioning portions of the operating spectral range of light into a second set of spectral bands, light of the second set of spectral bands stimulating the same color sensation;
wherein the first set of spectral bands and the second set of spectral bands have low or no overlap with each other; and
wherein the first set of spectral bands and the second set of spectral bands are determined independently of RGB designation of spectral bands.

33. A multi-spectral stereographic display apparatus comprising:
a multi-spectral illuminant having one or more light sources, the one or more light sources configured to provide a first set of emission bands of light, the first set of emission bands including spectral content within a first set of spectral bands, the first set of spectral bands including four or more spectral bands;
the one or more light sources configured to provide a second set of emission bands of light, the second set of emission bands including spectral content within a second set of spectral bands, the second set of spectral bands including four or more spectral bands;
wherein the first set of spectral bands and the second set of spectral bands have low or no overlap with each other; and
wherein the spectral bands of the first set of spectral bands and the spectral bands of the second set of spectral bands alternate with each other.

34. The apparatus of claim 33, light of the first set of spectral bands stimulating a color sensation, light of the second set of spectral bands stimulating the same color sensation.

35. The apparatus of claim 34, the color sensation being the sensation of white light.

36. The apparatus of claim 35, incorporated into a lighting system free of modifying the color balance of an original image content.

37. The apparatus of claim 33,
the first set of emission bands including spectral content within a first set of spectral bands in accordance with a first white point;
the second set of emission bands including spectral content within a second set of spectral bands in accordance with a second white point;
wherein the first white point is located within a discrimination space for low or no color difference and the second white point is located within the same discrimination space for low or no color difference.

38. The apparatus of claim 37, wherein the discrimination space is an achromatic discrimination space for neutral color.

39. The apparatus of claim 33, incorporated into a lighting system free of any electronic processing that provides a color balance modification that compensates for differing color balances.

40. A multi-spectral stereographic display system comprising:
a lighting portion including a multi-spectral illuminant having one or more light sources, the one or more light sources configured to provide first and second sets of emission bands of light, the first and second sets of emission bands including spectral content within first and second sets of lighting spectral bands, each of the first and second sets of lighting spectral bands including four or more spectral bands, the first and second sets of lighting spectral bands having low or no overlap with each other;
a viewing portion including first and second viewing filters apportioning portions of the operating spectral range into first and second sets of viewing spectral bands, each of the first and second sets of viewing spectral bands including four or more spectral bands, the first and second sets of viewing spectral bands having low or no overlap with each other;
wherein the first set of viewing spectral bands have at least some overlap with the first set of lighting spectral bands;
wherein the second set of viewing spectral bands have at least some overlap with the second set of lighting spectral bands;
wherein the spectral bands of the first and second sets of lighting spectral bands alternate with each other; and
wherein the spectral bands of the first and second sets of viewing spectral bands alternate with each other.

41. The system of claim 40,
wherein spectral content of the one or more light sources that passes through the first viewing filter stimulates a color sensation; and
wherein spectral content of the one or more light sources that passes through the second viewing filter stimulates the same color sensation.

42. The system of claim 41, the color sensation being the sensation of white light.

43. The system of claim 42, wherein the system is free of modifying the color balance of an original image content.

44. The system of claim 40,
the spectral content within the first and second sets of lighting spectral bands provided in accordance with first and second lighting white points;
the first and second sets of viewing spectral bands having first and second viewing white points based on a reference viewing illuminant;
wherein the first lighting white point is located within a discrimination space for low or no lighting color difference and the second lighting white point is located within the same discrimination space for low or no lighting color difference; and
wherein the first viewing white point is located within a discrimination space for low or no viewing color difference and the second viewing white point is located within the same discrimination space for low or no viewing color difference.

45. The system of claim 44, wherein the discrimination space for low or no lighting color difference or the discrimination space for no or low viewing color difference is an achromatic discrimination space for neutral color.

46. The system of claim 44, wherein the system is free of any electronic processing that provides a color balance modification that compensates for differing color balances.

47. The system of claim 40,
the lighting portion configured for providing at least one pair of stereographic images through light carrying the at least one pair of stereographic images;
the viewing portion configured for receiving the at least one pair of stereographic images through the light carrying the at least one pair of stereographic images; and
the viewing portion configured for separating each of the stereographic images independent of any polarization of the light carrying the at least one pair of stereographic images.

48. A multi-spectral stereographic display method comprising:
providing a first set of emission bands of light, the first set of emission bands including spectral content within a first set of spectral bands, the first set of spectral bands including four or more spectral bands;
providing a second set of emission bands of light, the second set of emission bands including spectral content within a second set of spectral bands, the second set of spectral bands including four or more spectral bands;
wherein the first set of spectral bands and the second set of spectral bands have low or no overlap with each other; and
wherein the spectral bands of the first set of spectral bands and the spectral bands of the second set of spectral bands alternate with each other.

49. A multi-spectral stereographic display method comprising:
providing a first set of emission bands of light, the first set of emission bands including spectral content within a first set of lighting spectral bands, the first set of lighting spectral bands including four or more spectral bands,
providing a second set of emission bands of light, the second set of emission bands including spectral content within a second set of lighting spectral bands, the second set of lighting spectral bands including four or more spectral bands,
the first and second sets of lighting spectral bands having low or no overlap with each other;
apportioning portions of an operating spectral range into a first set of viewing spectral bands by a first viewing filter,
apportioning portions of the operating spectral range into a second set of viewing spectral bands by a second viewing filter,
the first and second sets of viewing spectral bands having low or no overlap with each other;
wherein the first set of viewing spectral bands have at least some overlap with the first set of lighting spectral bands;
wherein the second set of viewing spectral bands have at least some overlap with the second set of lighting spectral bands;
wherein the spectral bands of the first and second sets of lighting spectral bands alternate with each other; and
wherein the spectral bands of the first and second sets of viewing spectral bands alternate with each other.

50. A multi-spectral stereographic display apparatus comprising:
a multi-spectral illuminant having one or more light sources, the one or more light sources configured to provide a first set of emission bands of light, the first set of emission bands including spectral content within a first set of spectral bands;
the one or more light sources configured to provide a second set of emission bands of light, the second set of emission bands including spectral content within a second set of spectral bands;
wherein the first set of spectral bands and the second set of spectral bands have low or no overlap with each other; and
wherein the spectral arrangement of the first set of spectral bands corresponds to natural band harmonics.

51. The apparatus of claim 50, wherein the spectral arrangements of the first and second sets of spectral bands correspond to natural resonant characteristics of one basic unit structure type.

52. The apparatus of claim 50, each of the first and second sets of spectral bands comprising more bands than the number of types of color receptors in a target viewer.

53. The apparatus of claim 50, an emission band of the first set of emission bands being provided as a result of one or more modifications in amplitude, width, or location of an original emission band.

54. A multi-spectral stereographic display system comprising:
a lighting portion including a multi-spectral illuminant having one or more light sources, the one or more light sources configured to provide first and second sets of emission bands of light, the first and second sets of emission bands including spectral content within first and second sets of lighting spectral bands, the first and second sets of lighting spectral bands having low or no overlap with each other;
a viewing portion including first and second viewing filters apportioning portions of the operating spectral range into first and second sets of viewing spectral bands, the first and second sets of viewing spectral bands having low or no overlap with each other;
wherein the first set of viewing spectral bands have at least some overlap with the first set of lighting spectral bands;
wherein the second set of viewing spectral bands have at least some overlap with the second set of lighting spectral bands; and
wherein the spectral arrangement of the first set of lighting spectral bands and the spectral arrangement of the first set of viewing spectral bands correspond to natural band harmonics.

55. The system of claim 54, wherein the spectral arrangement of the first set of lighting spectral bands and the spectral arrangement of the first set of viewing spectral bands correspond to natural resonant characteristics of one basic unit structure type.

56. The system of claim 54, each of the first set of lighting spectral bands and the first set of viewing spectral bands comprising more bands than the number of types of color receptors in a target viewer.

57. The system of claim 54, an emission band of the first set of emission bands being provided as a result of one or more modifications in amplitude, width, or location of an original emission band.

58. The system of claim 54,
the first viewing filter having a first set of viewing pass-bands; and
the first set of emission bands having steeper pass-band cut-off edges than the first set of viewing pass-bands.

59. A multi-spectral stereographic display method comprising:
providing a first set of emission bands of light, the first set of emission bands including spectral content within a first set of spectral bands;
providing a second set of emission bands of light, the second set of emission bands including spectral content within a second set of spectral bands;
wherein the first set of spectral bands and the second set of spectral bands have low or no overlap with each other; and
wherein the spectral arrangement of the first set of spectral bands corresponds to natural band harmonics.

60. A multi-spectral stereographic display method comprising:
providing a first set of emission bands of light, the first set of emission bands including spectral content within a first set of lighting spectral bands,
providing a second set of emission bands of light, the second set of emission bands including spectral content within a second set of lighting spectral bands,
the first and second sets of lighting spectral bands having low or no overlap with each other;
apportioning portions of an operating spectral range into a first set of viewing spectral bands by a first viewing filter,
apportioning portions of the operating spectral range into a second set of viewing spectral bands by a second viewing filter,
the first and second sets of viewing spectral bands having low or no overlap with each other;
wherein the first set of viewing spectral bands have at least some overlap with the first set of lighting spectral bands;
wherein the second set of viewing spectral bands have at least some overlap with the second set of lighting spectral bands; and
wherein the spectral arrangement of the first set of lighting spectral bands and the spectral arrangement of the first set of viewing spectral bands correspond to natural band harmonics

61. A multi-spectral stereographic display apparatus comprising:
a multi-spectral illuminant having one or more light sources, the one or more light sources configured to provide a first set of emission bands of light, the first set of emission bands including spectral content within a first set of spectral bands, light of the first set of spectral bands stimulating a color sensation;
the one or more light sources configured to provide a second set of emission bands of light, the second set of emission bands including spectral content within a second set of spectral bands, light of the second set of spectral bands stimulating the same color sensation;
wherein the first set of spectral bands and the second set of spectral bands have low or no overlap with each other; and
wherein the first set of spectral bands and the second set of spectral bands are determined independently of RGB designation of spectral bands.

62. A multi-spectral stereographic display method comprising:
providing a first set of emission bands of light, the first set of emission bands including spectral content within a first set of spectral bands, light of the first set of spectral bands stimulating a color sensation;
providing a second set of emission bands of light, the second set of emission bands including spectral content within a second set of spectral bands, light of the second set of spectral bands stimulating the same color sensation;
wherein the first set of spectral bands and the second set of spectral bands have low or no overlap with each other; and
wherein the first set of spectral bands and the second set of spectral bands are determined independently of RGB designation of spectral bands.

63. A multi-spectral stereographic display apparatus comprising:
means for providing a first set of spectral bands, the first set of spectral bands including four or more spectral bands;
means for providing a second set of spectral bands, the second set of spectral bands including four or more spectral bands;
wherein the first set of spectral bands and the second set of spectral bands have low or no overlap with each other; and
wherein the spectral bands of the first set of spectral bands and the spectral bands of the second set of spectral bands alternate with each other.

64. A multi-spectral stereographic display method comprising:
step for providing a first set of spectral bands, the first set of spectral bands including four or more spectral bands;
step for providing a second set of spectral bands, the second set of spectral bands including four or more spectral bands;
wherein the first set of spectral bands and the second set of spectral bands have low or no overlap with each other; and
wherein the spectral bands of the first set of spectral bands and the spectral bands of the second set of spectral bands alternate with each other.

65. A multi-spectral stereographic display apparatus comprising:
means for providing a first set of spectral bands;
means for providing a second set of spectral bands;
wherein the first set of spectral bands and the second set of spectral bands have low or no overlap with each other; and
wherein the spectral arrangement of the first set of spectral bands corresponds to natural band harmonics.

66. A multi-spectral stereographic display method comprising:
step for providing a first set of spectral bands;
step for providing a second set of spectral bands;
wherein the first set of spectral bands and the second set of spectral bands have low or no overlap with each other; and
wherein the spectral arrangement of the first set of spectral bands corresponds to natural band harmonics.

67. A multi-spectral stereographic display apparatus comprising:
means for providing a first set of spectral bands, light of the first set of spectral bands stimulating a color sensation;
means for providing a second set of spectral bands, light of the second set of spectral bands stimulating the same color sensation;
wherein the first set of spectral bands and the second set of spectral bands have low or no overlap with each other; and
wherein the first set of spectral bands and the second set of spectral bands are determined independently of RGB designation of spectral bands.

68. A multi-spectral stereographic display method comprising:
means for providing a first set of spectral bands, light of the first set of spectral bands stimulating a color sensation;
means for providing a second set of spectral bands, light of the second set of spectral bands stimulating the same color sensation;
wherein the first set of spectral bands and the second set of spectral bands have low or no overlap with each other; and
wherein the first set of spectral bands and the second set of spectral bands are determined independently of RGB designation of spectral bands.
